(19) United States
(12) Patent Application Publication
(10) Pub. No.: US 2026/0208529 A1
(43) Pub. Date: Jul. 23, 2026

(54) TIRES FOR VEHICLE WHEELS

(71) Applicant: Pirelli Tyre S.p.A., Milano (IT)

(72) Inventors: Maurizio Stefano GALIMBERTI, Milano (IT); Vincenzina BARBERA, Milano (IT); Massimo ZAMBITO MARSALA, Milano (IT); Luca GIANNINI, Milano (IT)

(73) Assignee: Pirelli Tyre S.p.A., Milano (IT)

(21) Appl. No.: 19/137,632

(22) PCT Filed: Dec. 19, 2023
(86) PCT No.: PCT/IB2023/062929

§ 371 Date: Jun. 10, 2025

(30) Foreign Application Priority Data
Dec. 22, 2022 (IT) 102022000026607

(51) Int. Cl. B60C 1/00; C08H 7/00; C08K 3/04; C08K 3/06; C08K 3/22; C08K 5/09; C08L 97/00

(52) U.S. Cl. CPC B60C 1/00; C08H 6/00; C08K 3/04; C08K 3/06; C08K 3/22; C08K 5/09; C08L 97/00; C08K 2003/2296

(57) ABSTRACT

The present invention relates to a novel adduct between lignin and a pyrrole derivative of formula (I) wherein R₁-R₄ and W have the meaning as defined in the description, to be used as reinforcing filler for vulcanisable elastomeric compositions suitable for the production of tire for vehicle wheels.

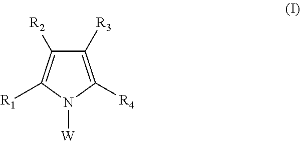

### FIELD OF THE INVENTION

The present invention relates to a novel adduct between lignin and a pyrrole derivative to be used as reinforcing filler for vulcanisable elastomeric compositions suitable for the production of tire for vehicle wheels, and to a tire for vehicle wheels comprising at least one structural component comprising a vulcanized elastomeric compound obtained by vulcanizing a vulcanisable elastomeric composition comprising such an adduct between lignin and pyrrole derivative as reinforcing filler in partial or total substitution of conventional reinforcing fillers.

### Prior Art

A tire for vehicle wheels typically comprises a carcass structure comprising at least one carcass layer having opposite lateral edges associated with respective bead structures, a belt structure applied in a radially external position to the carcass structure, and a tread band disposed in a position radially external to the belt structure.

The carcass structure is designed, in addition to supporting the weight of the vehicle, to resist the inflation pressure and all the lateral and longitudinal stresses to which the running tire is subjected following contact with the road surface.

The belt structure is designed to transfer the aforementioned lateral and longitudinal stresses to the carcass structure and helps to confer the desired features of structural strength, grip, driving stability, controllability, directionality, road grip, comfort and to maintain these performances overtime.

The bead structures are designed to withstand the circumferential, transverse and combined stresses that are transmitted between the wheel rim and the tire during normal conditions of use, for example in acceleration, braking and when turning, possibly even at high speed.

The several structural components of a finished tire comprise a vulcanized elastomeric compound. The matrix of vulcanized elastomeric compound is made through the vulcanization of an elastomeric composition comprising at least one diene elastomeric polymer, and at least one reinforcing filler in order to improve the features of the cross-linked products obtained, in particular the mechanical properties.

Due to its high reinforcing efficiency, carbon black is a particularly used reinforcing filler. However, carbon black represents a non-renewable raw material, deriving mainly from partial combustion processes of fossil fuels, mainly naphtha, methane gas, and other hydrocarbons. In addition, carbon black can be of environmental concern as it is a potential pollutant if not properly disposed of. The replacement or reduction of the use of carbon black therefore represents an objective not only of interest for tire manufacturers, but of common interest for the community.

The Applicant has perceived the need to supply more eco-sustainable and eco-compatible tires and components thereof, for example, through the reduction or replacement of raw materials from petroleum with raw materials produced from renewable sources with the aim of maintaining and possibly improve, the performance of the tire.

Among the most abundant biopolymers from renewable sources for application in tires, starch, cellulose, lignin, and hemicellulose may be mentioned as examples. In the past, various attempts have been made to use some of these materials as reinforcing agents, which also have a lower specific weight than traditional reinforcing fillers. Lignin, for example, has been used, as it is or modified in various ways, as a reinforcing filler in tire compounds.

Lignin is an organic polymer complex having a three-dimensional polymeric structure consisting of phenylpropane units, and belonging to the class of so-called phenylpropanoid compounds.

Lignins have very different compositions and molecular weights, both as a function of the biomass chosen and the process with which they are obtained. The composition varies both in terms of functional groups, mainly of the phenolic type, hydroxyl and carboxylic types, and in terms of molecular weight.

Research efforts have been made, both in the academic and industrial fields, to replace traditional fillers with biofillers, in particular lignin.

Vehicle wheel tires comprising lignin are described in patent applications US2010/0204368, WO2009/145784, JP2008/308615, JP2010/242023, JP2010/248282, JP2014/129509, CN102718995, CN103756060, WO2014/097108, WO2017/109672, WO2022/144759, IT102021000029213, and IT102021000029831, and in patents GB723751, GB836393, U.S. Pat. Nos. 2,610,954, 2,802,815, 2,906,718, 3,079,360, 3,163,614, 3,282,871, 3,296,158, 3,312,643, 3,364,158, 3,817,974, 3,984,362 and 3,991,022.

Hait, S., et al., (2021). Treasuring waste lignin as superior reinforcing filler in high cis-polybutadiene rubber: A direct comparative study with standard reinforcing silica and carbon black. Journal of Cleaner Production, Vol. 299, 126841, disclose the use of bis[3-(triethoxysilyl)propyl]tetrasulfide (TESPT) as the coupling agent in a rubber composition based on 100 phr of butadiene rubber (BR) using Mg-lignin, Na-lignin and kraft lignin as reinforcing fillers. The tensile properties of the compounds based on kraft lignin were found to be superior or even better as compared with a standard silica-silane system and reinforcing carbon black at equivalent loading.

### SUMMARY OF THE INVENTION

The Applicant has carried out an intense research activity in order to find the way to use lignin for the production of tire compounds, in partial or total replacement of the carbon black in the elastomeric compositions typically used for structural components of tires, with the aim of reducing the hysteresis of the compositions themselves, with consequent reduction of energy dissipation during use of the tire, and of fuel consumption, still maintaining or improving the static and dynamic mechanical characteristics.

Starting from the work of Hait, S., et al., the Applicant realized that TESPT releases ethanol upon condensing with the functional groups of the filler, and that the sulfur atoms contained in TESPT could give rise to premature vulcanization during mixing, also during the non-productive mixing step of elastomeric compositions.

The Applicant conducted an extensive work in realizing adducts between pyrrole derivatives and carbon black or silica reinforcing fillers with the aim of increasing their compatibility with elastomeric compositions, as described in WO2016/050887, WO2018/087685, WO2018/087688, WO2019/162873, and WO2020/225595.

The Applicant perceived that pyrrole derivatives could be used for preparing an adduct with lignin which could be used in partial replacement of reinforcing fillers, particularly carbon black, giving rise to a hybrid reinforcing filler system, which could behave as a reinforcing filler system in an elastomeric composition suitable for tire compounds.

After extensive experimentation, the Applicant has surprisingly found that an elastomeric composition comprising such a hybrid reinforcing filler system showed unexpected improved static and dynamic mechanical properties together with similar or improved hysteresis compared with elastomeric compositions comprising conventional carbon black reinforcing filler.

Continuing the experimentation, the Applicant has also surprisingly found that good results in terms of properties at break of elastomeric composition only comprising an adduct of lignin and a pyrrole derivative as reinforcing filler.

Therefore, in a first aspect thereof, the present invention relates to an adduct of lignin and a pyrrole derivative, wherein said lignin comprises at least one functional group selected from hydroxyl group (—OH), carboxyl group (—COOH), ester group (—COOR), and aldehyde group (—CHO), and wherein said pyrrole derivative has the following general formula (I):

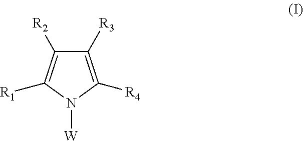

wherein
R₁-R₄ are independently selected from the group consisting of hydrogen atom, C₁-C₃ alkyl group, linear or branched C₂-C₁₀ alkenyl or alkynyl group, aryl group, linear or branched C₇-C₁₆ alkyl-aryl group, linear or branched C₇-C₁₆ alkenyl-aryl group, linear or branched C₇-C₁₆ alkynyl-aryl group, heteroaryl group, —CO—NHW′, and —CO—OW″;
W′ is selected from the group consisting of hydrogen atom, linear or branched C₁-C₁₀ alkyl group, linear or branched C₂-C₁₀ alkenyl or alkynyl group, aryl group, linear or branched C₇-C₁₆ alkyl-aryl group, linear or branched C₇-C₁₆ alkenyl-aryl group, linear or branched C₇-C₁₆ alkynyl-aryl group, and heteroaryl group,
W and W′ are independently selected from the group consisting of hydrogen atom, linear or branched C₁-C₁₀ alkyl group, linear or branched C₂-C₁₀ alkenyl or alkynyl group, linear or branched C₇-C₁₆ alkyl-aryl group, linear or branched C₇-C₁₆ alkenyl-aryl group, linear or branched C₇-C₁₆ alkynyl-aryl group, heteroaryl group, aryl group, cyclohexyl group, and a residue having the following formula (II):

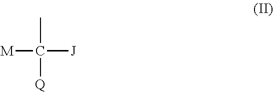

wherein M, Q and J are independently selected from the group consisting of hydrogen atom, amino group, hydroxyl group, linear or branched C₁-C₁₀ alkyl group, linear or branched C₂-C₁₀ alkenyl or alkynyl group, and a residue having the following formula (III):

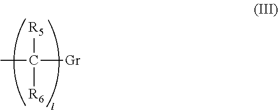

wherein I is an integer from 0 to 12, R₅ and R₆ are independently selected from the group consisting of hydrogen atom, linear or branched C₁-C₁₀ alkyl group, linear or branched C₂-C₁₀ alkenyl or alkynyl group, aryl group, linear or branched C₇-C₁₆ alkyl-aryl group, linear or branched C₇-C₁₆ alkenyl-aryl group, linear or branched C₇-C₁₆ alkynyl-aryl group, heteroaryl group, carboxyl group, and —(CH₂)ₒ—S—R₁₆, wherein o is an integer from 0 to 2, and R₁₆ is selected from hydrogen atom or C₁-C₃ alkyl group, and Gr is selected from the group consisting of the following residues (IV) to (IX):

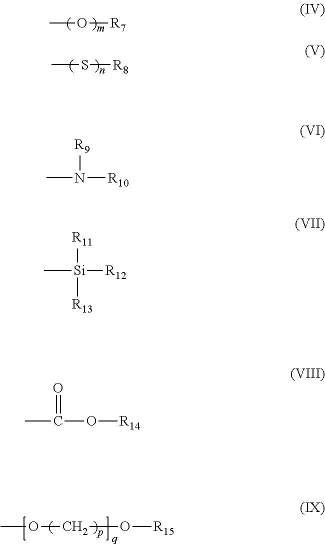

wherein m is an integer from 1 to 2, n is an integer from 1 to 4, p is an integer from 2 to 4, q is an integer from 1 to 30, R₇-R₁₅ are independently selected from the group consisting of hydrogen atom, linear or branched C₁-C₁₀ alkyl group, linear or branched C₂-C₁₀ alkenyl or alkynyl group, aryl, linear or branched C₇-C₁₆ alkyl-aryl group, linear or branched C₇-C₁₆ alkenyl-aryl group, linear or branched C₇-C₁₆ alkynyl-aryl group, and heteroaryl group, and R₁₁-R₁₃ can also be linear or branched C₁-C₁₀ alkoxy group.

In a second aspect thereof, the present invention relates to a tire for vehicle wheels comprising at least one structural component comprising a vulcanized elastomeric compound obtained by vulcanizing a vulcanisable elastomeric composition comprising:
(i) 100 phr of a composition comprising at least one diene elastomeric polymer selected from the group of natural and synthetic diene elastomeric polymers,
(ii) from 0 to 100 phr of a carbon black reinforcing filler,
(iii) from 2 to 100 phr of the adduct of lignin and a pyrrole derivative according to the first aspect of the present invention, and
(iv) from 0.1 to 12 phr of at least one vulcanizing agent.

In a third aspect thereof, the present invention relates to a green tire structural component comprising a vulcanisable elastomeric composition comprising:
(i) 100 phr of a composition comprising at least one diene elastomeric polymer selected from the group of natural and synthetic diene elastomeric polymers,
(ii) from 0 to 100 phr of a carbon black reinforcing filler,
(iii) from 2 to 100 phr of the adduct of lignin and a pyrrole derivative according to the first aspect of the present invention, and
(iv) from 0.1 to 12 phr of at least one vulcanizing agent.

In a fourth aspect thereof, the present invention relates to an elastomeric composition comprising:
(i) 100 phr of a composition comprising at least one diene elastomeric polymer selected from the group of natural and synthetic diene elastomeric polymers,
(ii) from 0 to 100 phr of a carbon black reinforcing filler,
(iii) from 2 to 100 phr of the adduct of lignin and a pyrrole derivative according to the first aspect of the present invention, and
(iv) from 0.1 to 12 phr of at least one vulcanizing agent.

### Definitions

According to the present invention, the term “adduct” is understood to mean a compound obtained by combining two or more components predominantly by means of covalent bonds and to a lesser extent by means of more labile intermolecular interactions, such as ionic bonds, Van der Waals forces, ion-dipole interactions and hydrogen bonds. In particular according to the present invention, the term “adduct” refers to adducts obtained from the interaction, via covalent bond and intermolecular interactions, between a pyrrole derivative, i.e. the compound of formula (I) as defined herein, and a lignin comprising at least one functional group selected from hydroxyl group (—OH), carboxyl group (—COOH), ester group (—COOR), and aldehyde group (—CHO).

The term “elastomeric composition” means a composition comprising at least one diene elastomeric polymer and one or more additives, which by mixing and possible heating provides an elastomeric compound suitable for use in tires and components thereof.

The components of the elastomeric composition are not generally introduced simultaneously into the mixer but typically added in sequence. In particular, the vulcanization additives, such as the vulcanizing agent and possibly the accelerant and retardant agents, are usually added in a downstream step with respect to the incorporation and processing of all the other components.

In the final vulcanisable elastomeric compound, the individual components of the elastomeric composition may be altered or no longer individually traceable as modified, completely or in part, due to the interaction with the other components, of heat and/or mechanical processing. The term “elastomeric composition” herein is meant to include the set of all the components that are used in the preparation of the elastomeric compound, regardless of whether they are actually present simultaneously, are introduced sequentially or are then traceable in the elastomeric compound or in the final tire.

The term “elastomeric polymer” indicates a natural or synthetic polymer which, after vulcanization, may be stretched repeatedly at room temperature to at least twice its original length and after removal of the tensile load substantially immediately returns with force to approximately its original length (according to the definitions of the ASTM D1566-11 Standard terminology relating to Rubber).

The term “diene elastomeric polymer” indicates a polymer or copolymer derived from the polymerization of one or more different monomers, among which at least one of them is a conjugated diene (conjugated diolefin).

The term “elastomeric compound” indicates the compound obtainable by mixing and possibly heating at least one elastomeric polymer with at least one of the additives commonly used in the preparation of tire compounds.

The term “vulcanisable elastomeric compound” indicates the elastomeric compound ready for vulcanization, obtainable by incorporation into an elastomeric compound of all the additives, including those of vulcanization.

The term “vulcanized elastomeric compound” means the material obtainable by vulcanization of a vulcanisable elastomeric compound.

The term “green” indicates a material, a compound, a composition, a component or a tire not yet vulcanized.

The term “vulcanization” refers to the cross-linking reaction in a natural or synthetic rubber induced by a typically sulfur-based cross-linking agent.

The term “vulcanizing agent” indicates a product capable of transforming natural or synthetic rubber into elastic and resistant material by virtue of the formation of a three-dimensional network of inter- and intra-molecular bonds. Typical vulcanizing agents are sulfur-based compounds such as elemental sulfur, polymeric sulfur, sulfur-donor agents such as bis[(trialkoxysilyl)propyl]polysulphides, thiurams, dithiodimorpholines and caprolactam-disulphide.

The term “vulcanization accelerant” means a compound capable of decreasing the duration of the vulcanization process and/or the operating temperature, such as sulphenamides, thiazoles, dithiophosphates, dithiocarbamates, guanidines, as well as sulfur donors such as thiurams.

The term “vulcanization activating agent” indicates a product capable of further facilitating the vulcanization, making it happen in shorter times and possibly at lower temperatures. An example of activating agent is the stearic acid-zinc oxide system.

The term “vulcanization retardant” indicates a product capable of delaying the onset of the vulcanization reaction and/or suppressing undesired secondary reactions, for example N-(cyclohexylthio)phthalimide (CTP).

The term “vulcanization package” is meant to indicate the vulcanizing agent and one or more vulcanization additives selected from among vulcanization activating agents, accelerants and retardants.

The term “reinforcing filler” is meant to refer to a reinforcing material typically used in the sector to improve the mechanical properties of tire rubbers, preferably selected from among carbon black, conventional silica, such as silica from sand precipitated with strong acids, preferably amorphous, diatomaceous earth, calcium carbonate, titanium dioxide, talc, alumina, aluminosilicates, kaolin, silicate fibres and mixtures thereof.

The term “mixing step (1)” indicates the step of the preparation process of the elastomeric compound in which one or more additives may be incorporated by mixing and possibly heating, except for the vulcanizing agent which is fed in step (2). The mixing step (1) is also referred to as “non-productive step”. In the preparation of a compound there may be several “non-productive” mixing steps which may be indicated with 1a, 1b, etc.

The term “mixing step (2)” indicates the next step of the preparation process of the elastomeric compound in which the vulcanizing agent and, possibly, the other additives of the vulcanization package are introduced into the elastomeric compound obtained from step (1), and mixed in the material, at controlled temperature, generally at a compound temperature lower than 120° C., so as to provide the vulcanisable elastomeric compound. The mixing step (2) is also referred to as “productive step”.

The term “structural component” of a tire means any layer of elastomeric material of the tire including reinforcing elements. A structural component of a tire may be a layer included in a reinforcing structure (for example carcass structure or belt structure) or it may be a reinforcement layer (for example zero degree belt layer, bead reinforcement layer or “flipper”, sidewall reinforcement layer or “chafer”).

The term “radial carcass structure” indicates a carcass structure comprising a plurality of reinforcing elements, each substantially lying along a respective plane passing through the radius of the tire. Such reinforcing elements may be incorporated in a single carcass ply or in several carcass plies (preferably two) radially superimposed on each other.

The terms “radial” and “axial” and the expressions “radially internal/external” and “axially internal/external” are used referring respectively to a direction substantially parallel to the equatorial plane of the tire and to a direction substantially perpendicular to the equatorial plane of the tire, i.e. respectively to a direction substantially perpendicular to the axis of rotation of the tire and to a direction substantially parallel to the axis of rotation of the tire.

The term “crossed belt structure” means a belt structure comprising a first belt layer including reinforcing elements substantially parallel to each other and inclined with respect to the equatorial plane of the tire by a predetermined angle and at least a second belt layer disposed in a radially external position with respect to the first belt layer and including reinforcing elements substantially parallel to each other but lying, with respect to the equatorial plane of the tire, with an inclination opposite to that of the reinforcing elements of the first layer.

The term “zero-degree belt structure” indicates a reinforcing layer comprising at least one reinforcing element wound on the belt structure according to a substantially circumferential winding direction, i.e. according to a winding direction having an inclination of less than 6° with respect to the equatorial plane of the tire.

The terms “circumferential” and “circumferentially” are used with reference to the direction of the annular extension of the tire, i.e. to the rolling direction of the tire, which corresponds to a direction lying on a plane coinciding with or substantially parallel to the equatorial plane of the tire.

By “substantially axial direction” it is meant a direction inclined, with respect to the equatorial plane of the tire, by an angle of between about 70° and about 90°.

By “substantially circumferential direction” it is meant a direction stretched, with respect to the equatorial plane of the tire, at an angle of between about 0° and about 10°.

For the purposes of the present description and the following claims, the term “phr” (acronym for parts per hundreds of rubber) indicates the parts by weight of a given elastomeric compound component per 100 parts by weight of the elastomeric polymer, considered net of any extension oils.

Unless otherwise indicated, all the percentages are expressed as percentages by weight.

### The Pyrrole Derivative

The pyrrole derivative useful in the present invention has the following general formula (I):

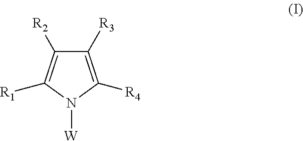

wherein
R₁-R₄ are independently selected from the group consisting of hydrogen atom, C₁-C₃ alkyl group, linear or branched C₂-C₁₀ alkenyl or alkynyl group, aryl group, linear or branched C₇-C₁₆ alkyl-aryl group, linear or branched C₇-C₁₆ alkenyl-aryl group, linear or branched C₇-C₁₆ alkynyl-aryl group, heteroaryl group, —CO—NHW′, and —CO—OW″;
W′ is selected from the group consisting of hydrogen atom, linear or branched C₁-C₁₀ alkyl group, linear or branched C₂-C₁₀ alkenyl or alkynyl group, aryl group, linear or branched C₇-C₁₆ alkyl-aryl group, linear or branched C₇-C₁₆ alkenyl-aryl group, linear or branched C₇-C₁₆ alkynyl-aryl group, and heteroaryl group,
W and W′ are independently selected from the group consisting of hydrogen atom, linear or branched C₁-C₁₀ alkyl group, linear or branched C₂-C₁₀ alkenyl or alkynyl group, linear or branched C₇-C₁₆ alkyl-aryl group, linear or branched C₇-C₁₆ alkenyl-aryl group, linear or branched C₇-C₁₆ alkynyl-aryl group, heteroaryl group, aryl group, cyclohexyl group, and a residue having the following formula (II):

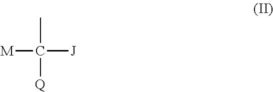

wherein M, Q and J are independently selected from the group consisting of hydrogen atom, amino group, hydroxyl group, linear or branched C₁-C₁₀ alkyl group, linear or branched C₂-C₁₀ alkenyl or alkynyl group, and a residue having the following formula (III):

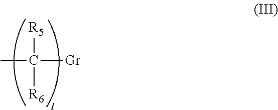

wherein I is an integer from 0 to 12, R₅ and R₆ are independently selected from the group consisting of hydrogen atom, linear or branched C₁-C₁₀ alkyl group, linear or branched C₂-C₁₀ alkenyl or alkynyl group, aryl group, linear or branched C₇-C₁₆ alkyl-aryl group, linear or branched C₇-C₁₆ alkenyl-aryl group, linear or branched C₇-C₁₆ alkynyl-aryl group, heteroaryl group, carboxyl group, and —(CH₂)ₒ—S—R₁₆, wherein o is an integer from 0 to 2, and R₁₆ is selected from hydrogen atom or C₁-C₃ alkyl group, and Gr is selected from the group consisting of the following residues (IV) to (IX):

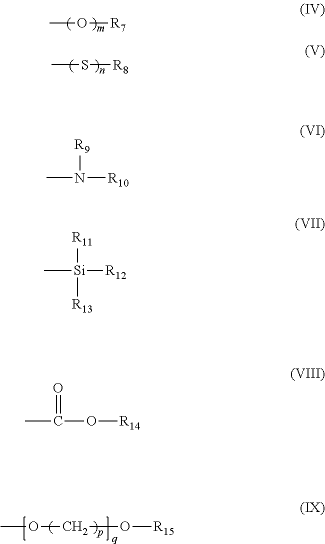

wherein m is an integer from 1 to 2, n is an integer from 1 to 4, p is an integer from 2 to 4, q is an integer from 1 to 30, R₇-R₁₅ are independently selected from the group consisting of hydrogen atom, linear or branched C₁-C₁₀ alkyl group, linear or branched C₂-C₁₀ alkenyl or alkynyl group, aryl, linear or branched C₇-C₁₆ alkyl-aryl group, linear or branched C₇-C₁₆ alkenyl-aryl group, linear or branched C₇-C₁₆ alkynyl-aryl group, and heteroaryl group, and R₁₁-R₁₃ can also be linear or branched C₁-C₁ alkoxy group.

According to an embodiment of the present invention, R₁-R₄ are independently selected from the group consisting of hydrogen atom, C₁-C₃ alkyl group, linear or branched C₂-C₅ alkenyl or alkynyl group, aryl group, linear or branched C₇-C₁₀ alkyl-aryl group, linear or branched C₇-C₁₀ alkenyl-aryl group, linear or branched C₇-C₁₀ alkynyl-aryl group, heteroaryl group, —CO—NHW′ and —CO—OW″.

According to an embodiment of the present invention, R₁-R₄ are independently selected from the group consisting of hydrogen atom, C₁-C₃ alkyl group, aryl group, heteroaryl group, —CO—NHW′ and —CO—OW″.

According to an embodiment of the present invention, at least one of R₁-R₄ is selected from the group consisting of —CO—NHW′ and —CO—OW″.

According to an embodiment of the present invention, W″ is selected from the group consisting of hydrogen atom, linear or branched C₁-C₃ alkyl group, linear or branched C₂-C₅ alkenyl or alkynyl group, aryl group, linear or branched C₇-C₁₀ alkyl-aryl group, linear or branched C₇-C₁₀ alkenyl-aryl group, linear or branched C₇-C₁₀ alkynyl-aryl group, and heteroaryl group.

According to an embodiment of the present invention, W′ is selected from the group consisting of hydrogen atom, linear or branched C₁-C₃ alkyl group, and heteroaryl group.

According to an embodiment of the present invention, W′ is selected from the group consisting of hydrogen atom, linear or branched C₁-C₃ alkyl group, linear or branched C₂-C₅ alkenyl or alkynyl group, linear or branched C₇-C₁₀ alkyl-aryl group, linear or branched C₇-C₁₀ alkenyl-aryl group, linear or branched C₇-C₁₀ alkynyl-aryl group, heteroaryl group, aryl group, cyclohexyl group, and a residue of formula (II) as described above.

According to an embodiment of the present invention, W is selected from the group consisting of hydrogen atom, linear or branched C₁-C₃ alkyl group, heteroaryl group, aryl group, cyclohexyl group, and a residue of formula (II) as described above.

According to an embodiment of the present invention, R₁-R₄ are independently selected from the group consisting of hydrogen atom, C₁-C₃ alkyl group.

According to an embodiment of the present invention, W is selected from the group consisting of hydrogen atom, linear or branched C₁-C₃ alkyl group, linear or branched C₂-C₅ alkenyl or alkynyl group, linear or branched C₇-C₁₀ alkyl-aryl group, linear or branched C₇-C₁₀ alkenyl-aryl group, linear or branched C₇-C₁₀ alkynyl-aryl group, heteroaryl group, aryl group, cyclohexyl group, and a residue of formula (II) as described above.

According to an embodiment of the present invention, W is selected from the group consisting of hydrogen atom, linear or branched C₁-C₃ alkyl group, heteroaryl group, aryl group, cyclohexyl group, and a residue of formula (II) as described above.

According to an embodiment of the present invention, M, Q and J are independently selected from the group consisting of hydrogen atom, amino group, hydroxyl group, linear or branched C₁-C₃ alkyl group, linear or branched C₂-C₅ alkenyl or alkynyl group, and a residue of formula (III) as described above.

According to an embodiment of the present invention, at least one of M, Q and J is a residue of formula (III) as described above.

According to an embodiment of the present invention, at least two of M, Q and J is a residue of formula (III) as described above.

According to an embodiment of the present invention, R₅ and R₆ are independently selected from the group consisting of hydrogen atom, linear or branched C₁-C₃ alkyl group, linear or branched C₂-C₅ alkenyl or alkynyl group, aryl group, linear or branched C₇-C₁₀ alkyl-aryl group, linear or branched C₇-C₁₀ alkenyl-aryl group, linear or branched C₇-C₁₀ alkynyl-aryl group, heteroaryl group, carboxyl group, or —(CH₂)ₒ—S—R₁₆, wherein o is an integer from 0 to 2, and R₁₆ is selected from hydrogen atom or C₁-C₃ alkyl group.

According to an embodiment of the present invention, R₅ and R₆ are independently selected from the group consisting of hydrogen atom, linear or branched C₁-C₃ alkyl group, carboxyl group, or —(CH₂)ₒ—S—R₁₆, wherein o is an integer from 0 to 2, and R₁₆ is selected from hydrogen atom or C₁-C₃ alkyl group.

According to an embodiment of the present invention, R₅ and R₆ are independently selected from the group consisting of hydrogen atom, linear or branched C₁-C₃ alkyl group.

According to an embodiment of the present invention, R₇-R₁₅ are independently selected from the group consisting of hydrogen atom, linear or branched C₁-C₃ alkyl group, linear or branched C₂-C₅ alkenyl or alkynyl group, aryl, linear or branched C₇-C₁₀ alkyl-aryl group, linear or branched C₇-C₁₀ alkenyl-aryl group, linear or branched C₇-C₁₀ alkynyl-aryl group, heteroaryl group, and carboxyl group, and R₁₁-R₁₃ can also be linear or branched C₁-C₅ alkoxy group.

According to an embodiment of the present invention, R₇-R₁₅ are independently selected from the group consisting of hydrogen atom, linear or branched C₁-C₃ alkyl group, heteroaryl group, and carboxyl group, and R₁₁-R₁₃ can also be linear or branched C₁-C₃ alkoxy group.

According to an embodiment of the present invention, when Gr is a residue of formula (VII), I is an integer from 0 to 4.

According to an embodiment of the present invention, m is 1, n is an integer from 1 to 2, p is an integer from 2 to 3, and q is an integer from 1 to 15.

According to an embodiment of the present invention, when Gr is a residue of formula (IV), I is an integer from 0 to 12 and R₇ is a hydrogen atom.

According to an embodiment of the present invention, when Gr is a residue of formula (VIII), I is an integer from 0 to 12 and R₁₄ is selected from the group consisting of hydrogen atom, linear or branched C₁-C₃ alkyl group, linear or branched C₂-C₅ alkenyl or alkynyl group, aryl, linear or branched C₇-C₁₀ alkyl-aryl group.

According to an embodiment of the present invention, any group represented by W, W′ or W″ as defined above can be optionally substituted by an alkyl, alkenyl, alkynyl, aryl, benzyl, amino, alkylamino, arylamino, benzylamino, aminoaryl, hydroxyl, or carboxyl group, preferably by a hydroxyl or carboxyl group.

According to an embodiment of the present invention, the heteroaryl group is selected from the group consisting of pyridine, pyrimidine, pyrrole, imidazole, furan, thiophene, indole, quinoline, and azulene.

According to an embodiment of the present invention, R₂-R₃ are independently selected from the group consisting of hydrogen atom, C₁-C₃ alkyl group, linear or branched C₂-C₅ alkenyl or alkynyl group, aryl group, linear or branched C₇-C₁₀ alkyl-aryl group, linear or branched C₇-C₁₀ alkenyl-aryl group, linear or branched C₇-C₁₀ alkynyl-aryl group, heteroaryl group, and R₁ and R₄ are independently selected from the group consisting of —CO—NHW′, and —CO—OW″.

According to an embodiment of the present invention, the pyrrole derivative useful in the present invention bears at least one group represented by residues (IV) to (IX) as described above, preferably wherein m is 1, n is an integer from 1 to 2, p is an integer from 2 to 3, q is an integer from 1 to 15, R₇-R₁₅ are independently selected from the group consisting of hydrogen atom, linear or branched C₁-C₃ alkyl group, and heteroaryl group, and R₁₁-R₁₃ can also be linear or branched C₁-C₃ alkoxy group.

The pyrrole derivative useful in the present invention can be prepared according to methods known in the art. In brief, a suitable primary amine can be reacted with a suitable diketone having the following formula (A):

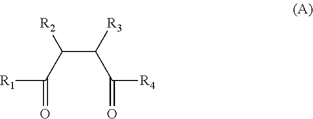

wherein R₁-R₄ have the meaning as described above.

According to an embodiment of the present invention, the suitable diketone is selected from the groups consisting of 2,5-hexanedione, 3,4-dimethyl-2,5-hexanedione, 2,5-heptanedione, 6-methylheptane-2,5-dione, 2,5-octanedione, 3,6-octanedione, 2,7-dimethyl-3,6-octanedione, and 2,2-dimethyl-3,6-octanedione, preferably 2,5-hexanedione, and 3,6-octanedione.

According to an embodiment of the present invention, the suitable primary amine has the following formula (B):

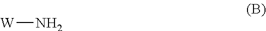

wherein W has the meaning as described above.

According to an embodiment of the present invention, W is selected from the group consisting of hydrogen atom, linear or branched C₁-C₃ alkyl group, heteroaryl group, aryl group, cyclohexyl group, and a residue of formula (II) as described above, preferably wherein at least one of M, Q and J is a residue of formula (III) as described above.

According to a preferred embodiment, the suitable primary amine is selected from the groups consisting of 2-amino-1,3-propanediol (serinole), 2-aminoethanol, 2-aminoacetic acid, 3-(trimethoxysilyl)propan-1-amine, 3-triethoxysilyl-propan-1-amine, N′,N′-dimethylpropan-1,3-diamine, 2-aminoethanethiol, 3-(aminomethyl)-3,5,5-trimethylcyclohexanamine, hexamethylenediamine, 4,4′-methylene-dicyclohexanamine, and 3-(diethoxyl(methoxy)silyl)propan-1-amine.

According to a specific embodiment, preferred examples of pyrrole derivatives useful in the present invention are:
2-(2,5-dimethyl-1H-pyrrol-1-yl) propane-1,3-diol (SP)

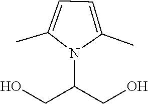

2,5-dimethyl-1-(3-(triethoxysilyl)propyl)-1H-pyrrole (APTESP)

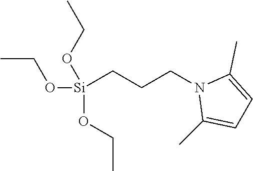 [SMILES: CCO[Si](CCCn1c(C)ccc1C)(OCC)OCC]

2-(2,5-dimethyl-1H-pyrrol-1-yl) acetic acid (GlyP).

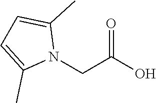

2-pyrrol-1-yl-1,3-propanediol
2,5-dimethyl-1-(3-(trimethoxysilyl)propyl)-1H-pyrrole (PPTMS)
O-(2-(2,5-dimethyl-1H-pyrrol-1-yl)propyl)-O′-(2-methoxyethyl) polypropylene glycol (PPGP)
2-(2,5-dimethyl-1H-pyrrol-1-yl)ethan-1-thiol (SHP)
1-(1,3-dihydroxypropan-2-yl)-5-((1,3-dihydroxypropan-2-yl) carbamoyl)-1H-pyrrole-2-carboxylic acid
1-(1,2-dihydroxypropan-3-yl)-5-((1,2-dihydroxy propan-3-yl)carbamoyl)-1H-pyrrole-2-carboxylic acid;
1-(2-hydroxyethyl)-5-((2-hydroxyethyl)carbamoyl)-1H-pyrrole-2-carboxylic acid;
1-benzyl-5-(benzylcarbamoyl)-1H-pyrrole-2-carboxylic acid;
1-octyl-5-(octylcarbamoyl)-1H-pyrrole-2-carboxylic acid;
1-(1-hydroxypropan-2-yl)-5-((1-hydroxypropan-2-yl)carbamoyl)-1H-pyrrole-2-carboxylic acid;
1-(2-mercaptoethyl)-5-((2-mercaptoethyl)carbamoyl)-1H-pyrrole-2-carboxylic acid;
1-(3-(triethoxysilyl)propyl)-5-((3-(triethoxysilyl)propyl)carbamoyl)-1H-pyrrole-2-carboxylic acid;
1-(carboxymethyl)-5-((carboxymethyl)carbamoyl)-1H-pyrrole-2-carboxylic acid; and
1-(2-aminoethyl)-5-((2-aminoethyl)carbamoyl)-1H-pyrrole-2-carboxylic acid

### The Lignin

Lignin is a synthesized biopolymer in the plant world and is second only to cellulose in terms of quantity produced. Biomass formed by cellulose and lignin represents approximately 70% of total biomass.

Lignin is a heavy and complex organic polymer formed mainly by phenolic compounds. In particular, lignin is composed of a cross-linked and three-dimensional polymer structure of phenylpropane units, above all phenylpropyl alcohols (coumaryl, coniferyl and sinapyl). The alcohols are synthesized by the plants by reduction of the corresponding acids by means of the enzyme cinnamyl-CoA: NADPH oxidoreductase.

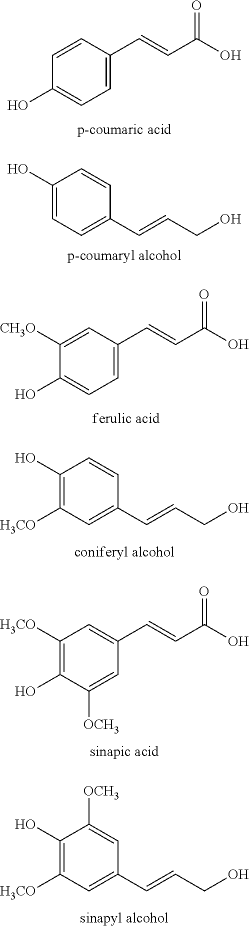

The components of the lignin are present in different quantities depending on the type of plant in which it forms. Coniferyl alcohol is the most abundant precursor of conifer lignin. Woody angiosperm (broad-leaved) lignin is derived above all from sinapyl alcohol. P-coumaryl, coniferyl and sinapyl alcohols are all present in comparable quantities in the composition of herbaceous plant lignin, mainly of the grass family.

The polymer structure of the lignin is very complex and has a three-dimensional form with a crosslink formation comprising ether bonds (C—O—C), carbon bonds (C—C) and ester bonds (CO—O—C) among the different phenylpropane units.

The main source of lignin comes from the papermaking industry and from the biocombustible production industry. In both cases, lignin represents a by-product which has to be separated from the main product, which is cellulose or bioethanol. Unpurified raw lignin obtained from the separation process is normally burnt to produce energy. The process used to separate the lignin from the other plant components (cellulose and hemicellulose) produces different types of lignin.

In industry, a distinction is made primarily between two types of raw lignin: sulfurated lignin, obtained by treatment processes which comprise a treatment with sulphates or sulphites (sulphate or Kraft process, sulphite process, semichemical process), and sulfur-free lignin, obtained by treatment processes which comprise a treatment with soda (soda pulping), with high-pressure steam (steam explosion) or with organic solvents (solvent pulping).

The “Soda-Process” does not operate with sulfur containing chemicals. Only sodium hydroxide in water is used as a pulping reagent. To achieve a satisfactory delignification grade the pulping is to be conducted at high temperature (up to 210° C.) leading to highly extended degradation of the polymeric sugars. The use of anthraquinone facilitates the lignin removal (“soda-anthraquinone-technique”) and makes this method industrially applicable.

The sulfite process was industrially realized with mix of sulfur salts (mostly Ca2+ and Mg2+) as active component. Varying the counter-ion the process can be carried out at different pH, from strong acidic to strong basic conditions. The classical approach operates at strong (calcium) or moderate (magnesium) acidic conditions. The sulfite component modifies the lignin chemically and makes it water soluble. Due to the great influence on ecology the process is not used extensively. However, it is often applied for chemical pulp production since a easily bleachable pulp may be provided.

The Kraft process implies the treatment of the pulp with a mixture of sodium sulfate, sodium carbonate, sodium hydroxide and sodium sulfide at elevated temperature. The lignin is removed from the lignocellulosic material in a form of water soluble alkali-lignin dissolved in black liquor. The lignin after Kraft process contains up to 3% sulfur.

The “organosolv” technique of lignin separation implies the addition of organic solvents to the pulping mixture to increase the lignin solubility and facilitate the subsequent bleaching. Mostly water miscible solvents, such as methanol, ethanol are used, thereby the veritable chemicals (acids, bases, sulfite or sulfide, or oxidative reagents) still serve as a pulping agent. The “organosolv” processes are generally divided into acidic and basic processes. Lignin extraction by “organosolv” processes are described, for example, in US2010/159522, US2013/0005952, US2009/0062516, WO92/013849, WO2009/092749, WO2011/014894, WO2011/149341, WO2012/027767, and WO2015/075080.

The alkaline metal salts of sulfonated lignins have a density of approximately 1.5 g/cm³, whereas sulfur-free lignins have a density of approximately 1.3 g/cm³. The density of raw lignins is therefore much lower than the density of carbon black.

Preferably, the lignin is selected from the group comprising Softwood Kraft lignin, Hardwood Kraft lignin, Soda Grass lignin, Wheat Straw lignin, Rice Husk lignin, lignin obtained through biorefinery processes, Organosolv lignin.

### The Adduct Between Lignin and Pyrrole Derivative

According to the present invention an adduct between lignin and pyrrole derivative is obtained by formation of covalent and non-covalent bonds.

As can easily be gathered from the chemical structure of the base components of lignin, the latter is particularly rich in hydroxyl groups (—OH), predominantly of the phenolic or alcoholic type and, to a lesser degree, of the carboxylic type, which make the lignin particularly suitable for functionalization by means of esterification reactions.

In esterification reactions, the hydroxyl groups of the lignin are reacted with a pyrrole derivative comprising a carboxylic group or an acyl group (for example an acylic halide such as acetyl chloride or an anhydride such as acetic anhydride) to form the corresponding ester. The esterification reaction involves all the hydroxyl groups, both of the phenolic and alcoholic type. The esterification reaction is generally carried out under heat, preferably under reflux conditions, in a suitable solvent using techniques well known to the man skilled in the art. The reaction can be carried out in the presence of a basic catalyst or an acidic catalyst (for example sulfuric acid).

The hydroxyl groups of the lignin also allow the reaction with a pyrrole derivative comprising an alkoxysilane group, such as for example 2,5-dimethyl-1-(3-(triethoxysilyl)propyl)-1H-pyrrole and 2,5-dimethyl-1-(3-(trimethoxysilyl)propyl)-1H-pyrrole. The reaction is generally carried out under heat in a suitable solvent using techniques well known to the man skilled in the art.

On the other hand, the presence of phenolic group makes the lignin able to undergo the reaction of Reimer-Tiemann, so obtaining a formylated lignin bearing aldehydic groups (—HC═O), which allow the functionalization by formation of an acetal or a hemiacetal. In such a case, the formylated lignin is reacted with a pyrrole derivative comprising one or more hydroxyl groups. The reaction is generally carried out under heat, preferably under reflux conditions, in a suitable solvent using techniques well known to the man skilled in the art. The reaction can be carried out in the presence of a basic catalyst or an acidic catalyst (for example sulfuric acid).

Additionally, the presence of ionic and non-ionic groups, such as hydroxyl, carboxy, amido, and amino groups, in both the lignin and the pyrrole derivatives allows the formation of several additional non-covalent bonds derived by intermolecular interactions, such as ionic bonds, Van der Waals forces, ion-dipole interactions and hydrogen bonds. Such non-covalent bonds contribute to a lesser extend to the binding of lignin and pyrrole derivative, and to the formation of the adduct as defined herein.

According to a preferred embodiment, the adduct between lignin and pyrrole derivative is present in the elastomeric composition in an amount equal to or higher than about 5 phr, preferably higher than about 10 phr. Preferably, the adduct between lignin and pyrrole derivative is present in the elastomeric composition in an amount lower than about 75 phr, preferably lower than about 50 phr.

### Diene Elastomeric Polymer

The diene elastomeric polymer that is used in the present invention may be selected from those commonly used in sulfur-cross-linkable elastomeric materials, which are particularly suitable for producing tires, i.e. from elastomeric polymers or copolymers with an unsaturated chain characterized by a glass transition temperature (Tg) generally lower than 20° C., preferably in the range of from 0° C. to −110° C. These polymers or copolymers may be of natural origin or may be obtained by solution polymerization, emulsion polymerization or gas-phase polymerization of one or more conjugated diolefins, optionally mixed with at least one comonomer selected from monovinylarenes and/or polar comonomers.

The conjugated diolefins generally contain from 4 to 12, preferably from 4 to 8 carbon atoms and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene or mixtures thereof. 1,3-butadiene and isoprene are particularly preferred.

Monovinylarenes, which may optionally be used as comonomers, generally contain from 8 to 20, preferably from 8 to 12 carbon atoms and may be selected, for example, from: styrene; 1-vinylnaphthalene; 2-vinylnaphthalene; various alkyl, cycloalkyl, aryl, alkylaryl or arylalkyl derivatives of styrene, such as, for example, α-methylstyrene, 3-methylstyrene, 4-propylstyrene, 4-cyclohexylstyrene, 4-dodecylstyrene, 2-ethyl-4-benzylstyrene, 4-p-tolyl-styrene, 4-(4-phenylbutyl)styrene, or mixtures thereof. Styrene is particularly preferred.

Polar comonomers that may optionally be used, can be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile or mixtures thereof.

Preferably, the diene elastomeric polymer which can be used in the present invention can be selected, for example, from: cis-1,4-polyisoprene (natural or synthetic, preferably natural rubber), 3,4-polyisoprene, polybutadiene (in particular polybutadiene with a high content of 1,4-cis), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

A diene elastomeric polymer functionalized by reaction with suitable terminating agents or coupling agents may also be used. In particular, the diene elastomeric polymers obtained by anionic polymerization in the presence of an organometallic initiator (in particular, an organolithium initiator) may be functionalized by reacting the residual organometallic groups derived from the initiator with suitable terminating agents or coupling agents such as, for example, imines, carbodiimides, alkyltin halides, substituted benzophenones, alkoxysilanes or aryloxysilanes.

### Carbon Black.

According to a preferred embodiment, the carbon black reinforcing filler which may be used in the present invention may be selected from those having a surface area of not less than 20 m²/g (as determined by STSA—Statistical Thickness Surface Area—according to ISO 18852:2005).

According to a preferred embodiment, the carbon black reinforcing filler is present in the elastomeric composition in an amount greater than about 15 phr, preferably greater than about 20 phr. Preferably, the carbon black reinforcing filler is present in the elastomeric composition in an amount of less than about 80 phr, preferably less than about 60 phr.

### Additional Reinforcing Filler

At least one additional reinforcing filler may advantageously be added to the elastomeric composition reported above, in an amount generally comprised between 1 phr and 70 phr, preferably between about 10 phr and about 60 phr. The additional reinforcing filler may be selected from those commonly used for cross-linked products, in particular for tires, such as silica, silicates, alumina, aluminosilicates, such as sepiolite, paligorskite also known as attapulgite, montmorillonite, alloisite and the like, possibly modified by acid treatment and/or derivatised, calcium carbonate, kaolin or mixtures thereof.

The silica that may be used in the present invention may generally be a pyrogenic silica or, preferably a precipitated silica, with a BET surface area (measured according to the ISO 5794/1 Standard) of between about 50 m²/g and about 500 m²/g, preferably between about 70 m²/g and about 200 m²/g.

Examples of silica reinforcing fillers which may be used in the present invention and are commercially available are the products known under the names of Hi-Sil® 190, Hi-Sil® 210, Hi-Sil® 233, Hi-Sil® 243, available from PPG Industries (Pittsburgh, Pa.); or the products known by the names of Ultrasil® VN2, Ultrasil® VN3, Ultrasil® 7000 from Evonik; or the products known by the names of Zeosil® 1165MP and 1115MP from Solvay.

According to an embodiment, the elastomeric composition may comprise a silane coupling agent able to interact with the silica possibly present as reinforcing filler and/or the silicates and to bind it to the diene elastomeric polymer during the vulcanization.

According to an embodiment, the silane coupling agent which may be used in the present invention may be selected from those having at least one hydrolysable silane group, which may be identified, for example, by the following general formula (II):

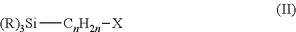

where the R groups, which may be the same or different, are selected from: alkyl, alkoxy or aryloxy groups or from halogen atoms, provided that at least one of the R groups is an alkoxy or aryloxy group; n is an integer of between 1 and 6, inclusive; X is a group selected from: nitrous, mercapto, amino, epoxide, vinyl, imide, chlorine, —(S)ₘCₙH₂ₙ—Si—(R)₃ and —S—COR, where m and n are integers of between 1 and 6 inclusive and the R groups are as defined above.

According to an embodiment, said silane coupling agent may be present in the elastomeric composition in an amount ranging between 0.01 phr and about 10 phr, preferably between about 0.5 phr and about 5 phr.

### Vulcanizing Agent

The elastomeric composition may be vulcanized according to known techniques, in particular with sulfur-based vulcanizing systems commonly used for diene elastomeric polymers. To this end, in the elastomeric compound obtained from the elastomeric composition after one or more thermomechanical treatment steps, a sulfur-based vulcanizing agent is incorporated together with vulcanization accelerants. In the final treatment step, the temperature is generally kept below 120° C. and preferably below 100° C., so as to prevent any undesired pre-cross-linking phenomena.

Preferably, said vulcanizing agent comprises sulfur-based vulcanizing systems comprising sulfur or sulfur-containing molecules (sulfur donors) together with vulcanization accelerants and/or activators known in the art.

Activators that are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, or mixtures thereof.

The accelerants which are commonly used may be selected from: dithiocarbamates, guanidine, thiourea, thiazoles, sulphenamides, thiurams, amines, xanthates or mixtures thereof.

According to a preferred embodiment, said cross-linkable elastomeric composition comprises an amount of vulcanizing agent equal to or greater than about 1 phr, preferably equal to or greater than about 2 phr.

Preferably, the amount of vulcanizing agent is less than or equal to about 7.5 phr, preferably less than or equal to about 7.

Advantageously, the amount of sulfur is between about 2 phr and about 6.5 phr.

### Other Additives

The elastomeric composition according to the present invention may comprise other commonly used additives, selected on the basis of the specific application for which the composition is intended. For example, said materials may be admixed with: antioxidants, anti-ageing agents, plasticisers, adhesives, anti-ozone agents, modifying resins, or mixtures thereof.

In particular, in order to improve the processability, said vulcanisable elastomeric composition may be admixed with a plasticiser generally selected from mineral oils, vegetable oils, synthetic oils or mixtures thereof, such as, for example, aromatic oil, naphthenic oil, phthalates, soybean oil or mixtures thereof. The amount of plasticiser generally ranges from 0 phr and about 70 phr, preferably from about 5 phr to about 30 phr.

### Preparation of the Elastomeric Composition

The elastomeric composition may be prepared by mixing the necessary amount of diene elastomeric polymer with the lignin adduct, the reinforcing filler, the vulcanizing agent, and any other additives possibly present according to the techniques known in the industry.

The mixing may be carried out, for example, using at least one batch mixer and/or at least one continuous mixer.

In the context of the present description and the subsequent claims, the term “batch mixer (or mixing device)” indicates a mixing device configured to be periodically fed with the various ingredients of the material to be prepared in predefined amounts and for mixing them for a predetermined time in order to obtain a batch of said material.

At the end of the mixing step, the entire batch of material obtained is completely discharged from the mixing device in a single solution. Examples of batch mixers are internal mixers of the type with tangential rotors (Banbury®) or with interpenetrating rotors (Intermix®).

In the context of the present description and of the subsequent claims, the term “continuous mixer (or mixing device)” indicates a mixing device configured to continuously feed the ingredients of the material to be prepared, typically by means of controlled dosage dispensers, to mix the ingredients in order to produce the material and to discharge it in a continuous flow (except possible stoppages of the mixing device due to maintenance, or change of the recipe of the material).

In the jargon of the elastomeric mixers sector, the continuous mixing device is sometimes referred to as: “mixing extruder”, which is herein considered equivalent to a “continuous mixer”.

The continuous mixer (in particular its active elements, such as screws or mixer satellites) is then provided with mixing portions able to impart a high shear stress to the material being mixed and, alternating with the mixing portions, transport portions able to impart a thrust to the material being processed to feed it from one longitudinal end to the other of the inner chamber. It may further be provided with possible redistribution portions.

Examples of continuous mixing devices are twin-screw or multi-screw mixers (e.g. ring mixers), co-penetrating and co-rotating, or planetary mixing devices.

Both the batch mixer and the continuous mixer are able to impart to the material to be produced with them sufficient energy to mix and homogeneously disperse the various components even in the case of cold feeding of the ingredients and, in the case of a material comprising an elastomeric component, to chew the elastomeric compound raising the temperature thereof so as to make it workable and plastic to facilitate the incorporation and/or distribution of the ingredients within the elastomeric polymeric matrix.

The elastomeric compound thus obtained may then be stored or sent directly to the subsequent production steps of the tire according to the present invention.

### The Tire

According to an embodiment, the tire for vehicle wheels according to the invention comprises
a carcass structure comprising at least a carcass ply having opposite lateral edges associated to respective bead structures;
optionally a belt structure applied in radially external position with respect to the carcass structure;
a tread band applied in a radially external position to said carcass structure and to said belt structure, if present, and
optionally, an underlayer and/or an anti-abrasive elongate member and/or a sidewall and/or a sidewall insert and/or a mini-sidewall and/or an underliner and/or a rubberising layer and/or flipper and/or chafer and/or a bead filler and/or a sheet.

According to an embodiment, the structural component according to the invention is selected from the group consisting of carcass structure, belt structure, additional belt layer, rubberising layer, sidewall, sidewall insert, anti-abrasive layer, bead filler, bead reinforcement layers (chafer and flipper), and tread band (single structure or cap-and-base structure).

According to a preferred embodiment, said structural component is an additional belt layer. Said additional belt layer is commonly known as a “zero degree belt”.

The carcass structure is intended to give the tire the desired features of structural integrity and strength, while the belt structure is also intended to transfer to the carcass structure the lateral and longitudinal stresses to which the running tire is subjected as a result of the contact with the road surface, so as to impart the desired performance of grip, driving stability, controllability, directionality, road grip and comfort. The zero degree reinforcing layer, when present, is instead intended to limit the radial elongation of the belt structure.

Preferably, said structural component is the carcass structure comprising a plurality of reinforcing elements. Preferably, said carcass structure is a radial carcass structure. Preferably, the plurality of reinforcing elements is incorporated in two carcass plies radially superimposed on each other.

Preferably, the belt structure comprises at least one reinforcing element wound on the carcass structure according to a substantially circumferential winding direction.

In one embodiment, at least one bead reinforcement layer may be associated with the carcass layer at or in proximity to a respective anchoring structure.

Preferably, said at least one bead reinforcement layer comprises at least one reinforcing element.

Said at least one bead reinforcement layer may be interposed between a respective turned up end flap of said at least one carcass layer and a respective anchoring structure.

More preferably, said at least one bead reinforcement layer may at least partially surround said anchoring structure or bead. This bead reinforcement layer is also referred to by the term “flipper”.

A sidewall reinforcement layer may be associated with the respective turned up end flap of the at least one carcass layer in an axially outermost position with respect to the respective annular anchoring structure.

More preferably, said at least one sidewall reinforcement layer may extend from said carcass structure along the sidewall towards the tread band. Such sidewall reinforcement layer is also referred to by the term “chafer”.

In a preferred embodiment, the structural component according to the invention is selected from the group consisting of carcass structure, belt structure, flipper, chafer, and rubberising layers.

The tire according to the invention may be used on two, three or four-wheeled vehicles. The tire according to the invention may be for summer or winter use or for all seasons.

The tire according to the invention may be a tire for passenger cars, including both automobile tires, such as for example the high-performance tires, and tires for light transport vehicles, for example vans, campers, pick-up, typically with total mass at full load equal to or less than 3500 kg.

The tire according to the invention may be a tire for motorcycles, such as for example motorcycles belonging to the scooter, road enduro, custom, hypersport, supersport, and sport touring categories. The term “tire for motorcycle wheels” means a tire having a high curvature ratio (typically greater than 0.200), capable of reaching high angles of inclination (roll angles) during cornering of the motorcycle.

The tire according to the invention may be a tire for bicycle wheels, such as for example for wheels of racing bicycles, off-road bicycles, and city bicycles. Racing bicycles comprise high performance bicycles for road or track competitions, such as, recumbent bicycles, time trial bicycles, triathlon bicycles, and/or so-called fitness bikes. Off-road bicycles comprise bicycles for uneven or irregular terrain, such as muddy, sandy, rocky, compact, soft ground, and so on, and include in particular mountain bikes (MTB) or all terrain bikes (ATB), conventionally divided into the Cross Country (XC), Marathon, Trail, All Mountain, Enduro, Freeride, and Downhill categories. City bicycles comprise bicycles for urban use on mainly asphalted road or cycleways, such as urban bikes, city bikes, trekking bikes and touring bikes.

### DRAWINGS

The description is given hereinafter with reference to the accompanying drawings, provided only for illustrative and, therefore, non-limiting purposes, in which:

FIG. 1 schematically shows a semi-sectional view of a tire for vehicle wheels according to the present invention.

FIG. 2 shows FT-IR (ATR) spectra of formylated lignin (curve B) and formylated lignin/SP adduct (curve A) of example 10.

FIG. 3 shows FT-IR (ATR) spectra of lignin (curve B) and lignin/APTESP adduct (curve A) of example 11.

FIG. 4 shows FT-IR (ATR) spectra of lignin (curve B) and lignin/GlyP adduct (curve A)) of example 12.

### DETAILED DESCRIPTION OF THE INVENTION

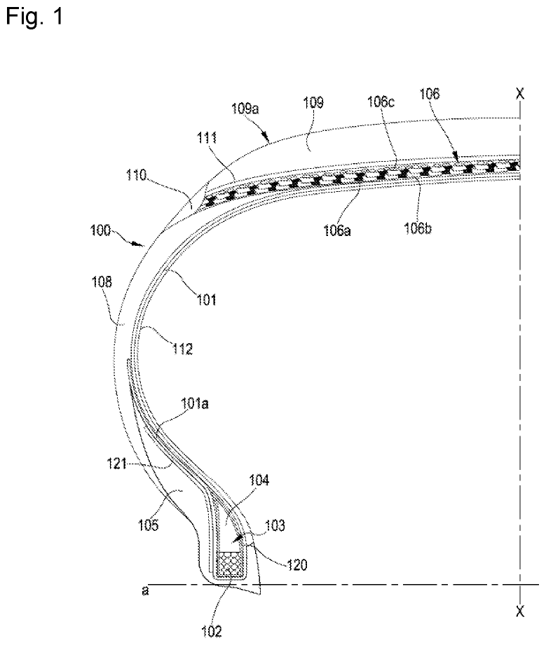

The present invention will be illustrated in further detail by means of an illustrative embodiment with reference to the accompanying FIG. 1, where “a” indicates an axial direction and “r” indicates a radial direction. For simplicity, FIG. 1 shows only a part of the tire, the remaining part not shown being identical and disposed symmetrically with respect to the radial direction “r”.

The reference numeral 100 indicates in FIG. 1 a tire for vehicle wheels, which generally comprises a carcass structure 101 having respectively opposite end flaps engaged with respective annular anchoring structures 102, called bead cores, possibly associated with a bead filler 104. The tire area comprising the bead core 102 and the filler 104 forms a bead structure 103 intended for anchoring the tire onto a corresponding mounting rim, not shown.

Each bead structure 103 is associated to the carcass structure by folding back of the opposite lateral edges of the at least one carcass layer 101 around the bead core 102 so as to form the so-called carcass flaps 101a as shown in FIG. 1.

The carcass structure 101 is possibly associated with a belt structure 106 comprising one or more belt layers 106a, 106b placed in radial superposition with respect to one another and with respect to the carcass structure 101, having typically metal reinforcing cords. Such reinforcing cords may have crossed orientation with respect to a circumferential extension direction of the tire 100. By “circumferential” direction we mean a direction generally facing according to the direction of rotation of the tire, or in any case slightly inclined with respect to the direction of rotation of the tire.

The belt structure 106 further comprises at least one radially external reinforcing layer 106c with respect to the belt layers 106a, 106b. The radially external reinforcing layer 106c comprises textile or metal cords, disposed according to a substantially zero angle with respect to the circumferential extension direction of the tire and immersed in the elastomeric material. Preferably, the cords are disposed substantially parallel and side by side to form a plurality of turns. Such turns are substantially oriented according to the circumferential direction (typically with an angle of between 0° and 5°), such direction being usually called “zero degrees” with reference to the laying thereof with respect to the equatorial plane X-X of the tire. By “equatorial plane” of the tire it is meant a plane perpendicular to the axis of rotation of the tire and which divides the tire into two symmetrically equal parts.

A tread band 109 of a vulcanized elastomeric compound is applied in a radially internal position with respect to the carcass structure 101 and/or if present (as in the illustrated case) to the belt structure 106.

In a radially external position, the tread band 109 has a rolling portion 109a intended to come into contact with the ground. Circumferential grooves, which are connected by transverse notches (not shown in FIG. 1) so as to define a plurality of blocks of various shapes and sizes distributed in the rolling portion 109a, are generally made in this portion 109a, which for simplicity is represented smooth in FIG. 1.

To optimise the performance of the tread, the tread band may be made in a two-layer structure.

Such two-layer structure comprises the rolling layer or portion 109a (called cap) and a substrate 111 (called base) forming the so-called cap-and-base structure. It is thus possible to use an elastomeric material capable of providing a low rolling resistance for the cap 109a and at the same time high resistance to wear and to the formation of cracks while the elastomeric material of the substrate 111 may be particularly aimed at a low hysteresis to cooperate in reducing rolling resistance. The under-layer 111 of vulcanized elastomeric compound may be disposed between the belt structure 106 and the rolling portion 109a.

Moreover, respective sidewalls 108 of vulcanized elastomeric compound are further applied in an axially external position to said carcass structure 101, each extending from one of the lateral edges of the tread band 109 up to the respective bead structure 103.

A strip consisting of elastomeric compound 110, commonly known as “mini-sidewall”, of vulcanized elastomeric compound may optionally be provided in the connecting zone between sidewalls 108 and the tread band 109, this mini-sidewall generally being obtained by co-extrusion with the tread band 109 and allowing an improvement of the mechanical interaction between the tread band 109 and the sidewalls 108. Preferably, the end portion of sidewall 108 directly covers the lateral edge of the tread band 109.

In some specific embodiments, such as the one illustrated and described herein, the stiffness of the bead 103 may be improved by providing a reinforcing layer 120 generally known as a “flipper” in the tire bead.

The flipper 120 is wrapped around the respective bead core 102 and the bead filler 104 so as to at least partially surround them. The flipper 120 is disposed between the carcass layer 101 and the bead structure 103. Usually, the flipper 120 is in contact with the carcass layer 101 and said bead structure 103. The flipper 120 typically comprises a plurality of metal or textile cords incorporated in a vulcanized elastomeric compound.

In some specific embodiments, such as the one illustrated and described herein, the bead structure 103 may further comprise a further reinforcing layer 121 which is generally known by the term of “chafer” and which has the function to increase the rigidity and integrity of the bead structure 103.

The chafer 121 usually comprises a plurality of cords incorporated in a vulcanized elastomeric compound; such cords are generally made of textile material (for example aramid or rayon), or of metallic material (for example steel cords).

Optionally, an anti-abrasive strip 105 is disposed so as to wrap the bead structure 103 along the axially internal and external and radially internal areas of the bead structure 103, thus interposing itself between the latter and the wheel rim when the tire 100 is mounted on the rim.

Moreover, a radially internal surface of tire 100 is preferably internally lined by a layer of substantially airtight elastomeric material, or so-called liner 112.

According to an embodiment not shown, the tire may be a tire for motorcycle wheels. The profile of the straight section of the tire for motorcycle (not shown) has a high transversal curvature since it must guarantee a sufficient footprint area in all the inclination conditions of the motorcycle. The transverse curvature is defined by the value of the ratio between the distance f of the ridge of the tread from the line passing through the laterally opposite ends of the tread itself, measured on the equatorial plane of the tire, and the width C defined by the distance between the laterally opposite ends of the tread itself. A tire with high transverse curvature indicates a tire whose transverse curvature ratio (f/C) is at least 0.20.

The belt structure 106, and/or the carcass structure 101, and/or the bead structure 103, such as the flipper 120 and/or the chafer 121, may be advantageously made with the elastomeric composition comprising an adduct between lignin and pyrrole derivative according to the present invention, because a lower hysteresis means (i) a lower dissipation of energy in the form of heat during driving, preventing the onset of operating temperatures that are too high which may risk compromising the integrity of the tire, and (ii) lower fuel consumption.

The building of the tire 100 as described above is carried out by assembling respective semi-finished products onto a forming drum, not shown, by at least one assembly device.

At least a part of the components intended to form the carcass structure 101 of the tire 100 is built and/or assembled on the forming drum. More particularly, the forming drum is intended to first receive the possible liner 112, and then the carcass ply 101. Thereafter, devices non shown coaxially engage one of the annular anchoring structures 102 around each of the end flaps, position an external sleeve comprising the belt structure 106 and the tread band 109 in a coaxially centred position around the cylindrical carcass sleeve and shape the carcass sleeve according to a toroidal configuration through a radial expansion of the carcass ply 101, so as to cause the application thereof against a radially internal surface of the external sleeve.

After building of the green tire 100, a molding and vulcanization treatment is generally carried out in order to determine the structural stabilization of the tire 100 through vulcanization of the elastomeric compounds, as well as to impart a desired tread pattern on the tread band 109 and to impart any distinguishing graphic signs at the sidewalls 108.

The present invention will be further illustrated below by means of a number of preparatory examples, which are provided for indicative purposes only and without any limitation of the present invention.

### EXAMPLES

### Characterization Methods

### Elemental Analysis

Elemental analysis was carried out using a Elementary Analyze Costech ECS mod. 4010.

### FT-IR Analysis

The IR spectra were recorded in transmission mode (128 scan and 4 cm⁻¹ resolution) using self-supported silica disk made by potassium bromide and small amount of sample. The infrared spectroscopy disk was obtained from a disk machine by increasing the pressure. Thermo Electron Continuum IR microscope coupled with a FT-IR Nicolet Nexus spectrometer was used for the bulk measurement

### ¹H-NMR Analysis

NMR spectra were recorded on a BrukerAV 400 (400 MHz).

### Tollens' Reagent.

The Tollens' reagent is a colorless, basic, aqueous solution containing silver ions coordinated to ammonia [Ag(NH₃)²⁺]. It was prepared using a two-step procedure:
STEP 1: Aqueous silver nitrate was mixed with aqueous sodium hydroxide to lead to the formation of silver hydroxide, which in turn dissociates to give silver oxide;
STEP 2: Aqueous ammonia was added drop-wise until the precipitated silver oxide completely dissolves.

### MDR Rheometric Analysis

MDR rheometric analysis was performed with a sulfur based system, by using a rheometer Monsanto R.P.A. 2000 using the following procedure: 5.0 g of green compound were charged into the RPA at 50° C. for 1 minute and the first strain-sweep test was conducted (low deformations, 0.1-25% strain) at 50° C. The sample was then cross-linked at 170° C. for 10′ at 1.7 Hz of frequency and with an oscillation angle of 6.98% (0.5 rad).

The following parameters were obtained: Minimum torque (M_{L}), Maximum torque (M_{H}), induction time (t_{S1}) and times to achieve the optimum level of vulcanization (t₉₀), curing rate. The curing rate was calculated by using the following equation:

$$Curing Rate = \frac{{M}_{H} - {M}_{L}}{{t}_{90} - {t}_{s 1}}$$

Dynamic-Mechanical Analysis in the Shear Mode. Strain Sweep Test

The storage G′ modulus, the loss G″ modulus and Tan Delta were determined by using a rheometer Monsanto R.P.A. 2000 using the following procedure: 5.0 g of green compound were charged into the RPA at 50° C. for 1 minute and the first strain-sweep test was conducted (low deformations, 0.1-25% strain) at 50° C. The sample was then cross-linked at 170° C. for 10′ at 1.7 Hz of frequency and with an oscillation angle of 6.98% (0.5 rad). After vulcanization, the sample was kept at 50° C. for 20 minutes. The final values of G′, G″ and Tan Delta were obtained with a strain sweep test at low deformations (0.1-25% strain) at 50° C. and with 1 Hz frequency.

### Dynamic-Mechanical Analysis in the Axial Mode.

The dynamic-mechanical properties in the axial mode, the storage E′ modulus, the loss E″ modulus and Tan Delta were measured using an Instron dynamic device in the traction-compression mode according to the following methods. The crosslinked elastomers with a cylindrical form (length=25 mm; diameter=12 mm) were kept at the prefixed temperature of 10° C., 23° C. and 70° C. for the whole duration of the test. The samples were initially pre-compressed up to a 25% longitudinal deformation with respect to the initial length and then submitted to a dynamic sinusoidal strain with an amplitude of ±3.5% with respect to the original length. The frequency used was 100 Hz. The measured properties were dynamic storage modulus (E′), dynamic loss modulus (E″) and consequently tan delta (loss factor) through the ratio of the two moduli (E″/E′). Each modulus was plotted against temperature for the frequency used (100 Hz) to observe the effect of temperature on the dynamic mechanical properties in each sample.

### Tensile Test

Tensile strength test was carried out according to ISO 37 standard at 23° C. for each sample, using Zwick Roell Z010. Tensile testing is a destructive test process that provides information about the tensile strength, yield strength, and ductility of the material. It measures the force required to break a specimen and the extent to which the specimen stretches or elongates to that breaking point. Tensile measurements were determined on samples of the elastomeric compounds vulcanized at 170° C. for 10 minutes. Three replicates of each rubber compound were prepared and tested to reduce any kind of error.

The stress at 50% (Ca0.5), 100% (Ca1), 200% (Ca2), and 300% elongation (Ca3), together with stress at break (CR) and elongation at break (AR) were evaluated through this test.

### Synthesis of Pyrrole Derivatives

### Example 1

### Synthesis of 2-(2,5-dimethyl-1H-pyrrol-1-yl) propane-1,3-diol (SP)

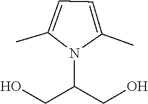

A mixture of 2,5-hexanedione (8.10 g; 0.0709 mol) and 2-aminopropane-1,3-diol (6.46 g; 0.0709 mol) was poured into a 100 mL round bottomed flask equipped with magnetic stirrer. The mixture was then stirred (300 rpm), at 150° C. for 4 hours. Afterwards the reaction mixture was cooled down to room temperature. 11.76 g of pure dark amber and viscous product was obtained. ¹H NMR (CDCl₃, 400 MHz); δ (ppm)=2.27 (s, 6H); 3.99 (m, 4H); 4.42 (quintet, 1H); 5.79 (s, 2H). ¹³C NMR (DMSO-6, 100 MHz); δ (ppm)=127.7; 105.9; 71.6; 61.2; 13.9.

### Example 2

### Synthesis of 2,5-dimethyl-1-(3-(triethoxysilyl)propyl)-1H-pyrrole (APTESP)

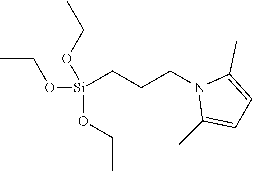 [SMILES: CCO[Si](CCCn1c(C)ccc1C)(OCC)OCC]

3.76 g of 3-(triethoxysilyl) propan-1-amine (0.017 mol) and 1.94 g of 2,5-hexanedione (0.017 mol) were poured in a 250 mL round bottom flask equipped with magnetic stirrer. The mixture was then stirred (300 rpm), at 155° C. for 4 hours with a reflux condenser was installed, and subsequently without reflux condenser for another 30 minutes. Afterwards the reaction mixture was cooled down to room temperature. ¹HNMR (CDCl₃, 400 MHz); δ (ppm)=5.73 (s, 2H, CH), 3.80 (m, 6H, O—CH₂), 3.70 (m, 2H, N—CH₂), 2.20 (s, 6H, CH₃), 1.71 (m, 2H, CH₂), 1.22 (m, 2H, CH₂), 0.62 (m, 3H, CH₃). ¹³C-NMR (CDCl₃, 100 MHz); δ (ppm)=127.6, 105.6, 56.1, 51.05, 27.01, 19.2, 13.01, 12.51

### Example 3

### Synthesis of 2-(2,5-dimethyl-1H-pyrrol-1-yl) acetic acid (GlyP)

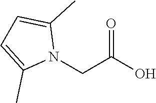

1 g of 2-aminoacetic acid (0.013 mol) and 1.52 g of 2,5-hexanedione (0.013 mol) were poured in a 50 ml round bottom flask equipped with magnetic stirrer. The mixture was left to stir at 75° C. for 2 hours. After this time, the reaction mixture was cooled to room temperature.

¹H NMR (CDCl3, 400 MHz); δ (ppm)=9.68 (1H, COOH), 5.76 (s, 2H, CH), 4.47 (s, 2H, CH₂), 2.14 (s, 6H, CH₃). 13C NMR (CDCl3, 100 MHz); δ (ppm)=173.16, 128.02, 105.50, 45.20, 12.28.

### Example 4

### Synthesis of 2-pyrrol-1-yl-1,3-propanediol

1.32 g of 2,5-dimethoxyltetrahydrofuran (10 mmol), 1 g of serinol (11 mmol) and 50 ml of HCl 0.1 N (5 mmol) are measured at reflux for one night in a 100-ml flask having a neck equipped with a magnetic reflux stirrer. At the end of the reaction, the pH of the solution is neutralized by adding NaHCO₃ and the solvent is moved from the reaction mixture to the rotary evaporator. The residue is therefore dissolved in ethyl acetate several times in order to extract the reaction product. After weighing, taking into account the purity of the composition detected by the NMR, a yield equal to 92% is estimated.

### Example 5

### Synthesis of 2,5-dimethyl-1-(3-(trimethoxysilyl)propyl)-1H-pyrrole (PPTMS)

A 100-mL single-neck flask equipped with a magnetic stirrer is charged with 1 g (5.58 mmol) of 3-(trimethoxysilyl)propan-1-amine and 0.640 g (5.58 mmol) of 2,5-hexanedione. The mixture is stirred for 6 hours at 150° C. The product is isolated as a sticky solid of an intense light yellow color and is analyzed by gas chromatography coupled to mass spectrometry (GC-MS) and nuclear magnetic resonance (NMR). The GC-MS analysis showed the compound 2,5-dimethyl-1-(3-(trimethoxysilyl)propyl)-1H-pyrrole as well as unreacted 3-(trimethoxysilyl)propan-1-amine. The yellow solid was then dissolved in dichloromethane. The solution obtained was washed with deionized water. The organic phase was dried over Na₂SO₄ and thoroughly dried at reduced pressure. The solid isolated is the pure compound 2,5-dimethyl-1-(3-(trimethoxysilyl)propyl)-1H-pyrrole. The weight of this compound allowed us to calculate a yield equal to 89%.

### Example 6

### Synthesis of O-(2-(2,5-dimethyl-1H-pyrrol-1-yl)propyl)-O′-(2-methoxyethyl) polypropylene glycol (PPGP)

A 100-mL single-neck flask equipped with a magnetic stirrer is charged with 1 g (1.6 mmol) of O-(2-aminopropyl)-O′-(2-methoxyethyl)polypropylene glycol (Mn=600) and 0.190 g (1.6 mmol) of 2,5-hexanedione. The mixture is stirred for 6 hours at 150° C. The product is isolated as a very viscous amber-colored liquid and is analyzed by nuclear magnetic resonance (NMR), which showed only the expected compound O-(2-(2,5-dimethylpyrrol-1-yl)propyl)-O′-(2-methoxyethyl)polypropylene glycol. The weight found and the chemical purity observed by NMR analysis allowed evaluation of a yield equal to 97%.

### Example 7

### Synthesis of 2-(2,5-dimethyl-1H-pyrrol-1-yl)ethan-1-thiol (SHP)

2.93 g (0.02577 mol) of 2-aminoethanethiol hydrochloride were introduced, under a constant current of N₂, into a 50 ml round-bottomed two-necked flask, previously dried in the oven, and the system was brought up to 50° C. with stirring (300 rpm) until complete dissolution.

The mixture was then brought back to room temperature, and 2.93 g (0.02577 mol) of 2,5-hexanedione were injected into the flask under a current of N₂. The mixture was left under stirring (300 rpm) at room temperature for 12 hours. Next, 1.5 g of 2-aminoethanethiol hydrochloride were added, the temperature was brought up to 50° C., and the mixture was left under stirring for one hour. The pure product was obtained by washing with water (3×10 mL). 3.1 g of product were obtained (yield=77.5%).

¹H NMR (D₂O, 400 MHz); δ (ppm)=2.05 (s, 6H); 2.9 (m, 4H); 3.33 (t, 1H); 3.43 (t, 1H); 5.42 (s, 2H).

### Example 8

### Synthesis of 1-(1,3-dihydroxypropan-2-yl)-5-((1,3-dihydroxypropan-2-yl) carbamoyl)-1H-pyrrole-2-carboxylic acid

3-Hydroxy-2-oxo-2H-pyran-6-carboxylic acid (135 mg, 0.87 mmol) and serinol (2-amino-1,3-propanediol, 455 mg, 4.87 mmol) were loaded into a 25 ml round bottomed flask. The heterogeneous system was heated at 60° C., then closed and maintained under stirring at this temperature until completion of the reaction as evidenced by ¹H-NMR and ¹³C-NMR analysis of a sample of the reaction mixture. 1-(1,3-dihydroxypropan-2-yl)-5-((1,3-dihydroxypropan-2-yl)carbamoyl)-1H-pyrrole-2-carboxylic acid (compound 1) was then isolated by column chromatography (75% yield).

### Synthesis of Formylated Lignin

### Example 9

### Lignin Formylation Via Reimer-Tiemann Reaction

10 g of lignin and 4.73 g potassium hydroxide were placed in a 250 ml flask at room temperature and stirred until a uniform slurry mixture was obtained. A small amount of deionized water was added to make the mixture less viscous. Chloroform was added to the mixture and the reaction system was closed and stirred for 2 hours. Deionized water was then added and the pH of the solution was adjusted to 7 with acetic acid to promote formylated lignin precipitation. The solution was filtered to recover the formylated lignin, which was then washed with abundant deionized water to remove reagent residues. The formylated lignin was dried at room temperature for 48 hours.

### Characterization of Formylated Lignin

Lignin oximation was performed for the quantitative evaluation of the carbonyl groups present both in lignin and in formylated lignin.

Hydroxylamine hydrochloride and triethanolamine (TEA) in excess was used as an oximation mixture. TEA is needed to shift the chemical equilibrium towards a fully oximated product. The portion of TEA unreacted is then titrated with HCl of known concentration by potentiometric titration to pH 3.3. (Faix, O., Andersons, B., & Zakis, G. (1998). Determination of carbonyl groups of six round robin lignins by modified oximation and FTIR spectroscopy https://doi.org/10.1515/hfsg.1998.52.3.268). The oximation solution was a water-alcohol solution with NH₂OH·HCl 0.2 N and TEA 0.08 N. For its preparation, 1.2 g of TEA were dissolved in 96% alcohol in a 50 ml volumetric flask (TEA stock). In a second 50 ml volumetric flask, 0.7 g of NH₂OH·HCl were dissolved in a 5 ml of water. From TEA stock, 25 ml solution was taken and put into the second flask; then alcohol was added until the reaching volume.

80 mg of lignin (either pristine or formylated) were placed into sealable cap-tube, dissolved in 2 ml DMSO, and 5 ml of oximation solution were added. Air in the tube was expelled with nitrogen and the tube was then sealed. The closed tube was heated at 80° C. for two hour and stirred at 300 rpm. The cooled solution was then transferred into a beaker and a little amount of water (about 1 ml) was added. The excess of TEA was potentiometrically titrated with 0.1 N HCl to pH 3.3. The amount of carbonyl groups was calculated using the following equation.

$$\% CO = ( \frac{{a}_{0} - a}{A} - \frac{{b}_{0} - {c}_{0}}{C} ) * f * 280.1$$

where a₀, b₀, c₀ are the volume of 0.1 N HCl (ml) used for blank titration, a is the volume of 0.1 N HCl (ml) used for sample titration, A is the weight of lignin or formylated lignin (mg) used for the analysis, C is the weight of lignin or formylated lignin (mg) in blank c₀, f is the titer of 0.1 N HCl and 280.1 is the mass of CO group (mg) equivalent to 1 ml of 0.1 N HCl multiplied with 100.

Because TEA is used in excess, carboxylic or other strong acidic groups in Lignin or Formylated lignin may consume TEA during oximation. This is a source of apparent CO increase. To avoid errors of this type, a second pair of blank experiments (blank b₀ and c₀) is necessary.

To check the reproducibility of the method, each titration was performed three times. The final volume of HCl 0.1 N of each titration is derived from the mathematical average of the volumes found in each test for the same titration. The results of the oximation reaction are reported in the following table 1.

TABLE 1

| Sample | % CO | Mmol CO/g lignin |
|---|---|---|
| Pristine lignin | 0.21 | 0.08 |
| Formylated lignin | 1.92 | 0.62 |

As shown in Table 1, pristine lignin presented a lower CO content than formylated lignin. Specifically, 0.21% and 1.92% were found, respectively. This result showed that the Reimer-Tiemann reaction is suitable for lignin formylation, resulting in the generation of aldehydic groups.

### Synthesis of Lignin-Pyrrole Adducts

### Example 10

Preparation of Lignin/SP Adduct. Reaction of Formylated Lignin with SP

10 g of formylated lignin was dispersed in 50 ml toluene while 1 g of SP was solubilized in 50 ml THF. The two solutions were mixed and stirred in a 250 ml flask for 10 hours at the temperature of 140° C. with the addiction of 1% w/w of acid catalyst (H₂SO₄). Dean-Stark apparatus was used in order to remove water formed during the reaction and shifts the equilibrium towards the formation of the product. The latter was finally recovered by filtration and washed with deionized water to remove the unreacted SP.

The formylated lignin/SP adduct was subjected to Tollens' test, FT-IR (ATR) analysis, and elemental analysis.

Tollens test was performed as a qualitative test, in order to check the presence of aldehyde functionalities. Small aliquots of pristine lignin, formylated lignin and formylated lignin/SP adduct were placed into three different glass test tubes and the Tollens reagent was added. The tubes were sonicated for 15 minutes in order to facilitate the solubilization of the lignin. The tubes were then heated in an oil bath at 50° C. for 1 hour and eventually stored at room temperature for 24 hours.

The vial containing formylated lignin produced a silver mirror unlike the bottle containing pristine lignin and formylated lignin/SP adduct. The absence of the silver mirror in the vial with formylated lignin/SP adduct can be assumed to the substantial absence of aldehydic groups, due to their reaction with SP.

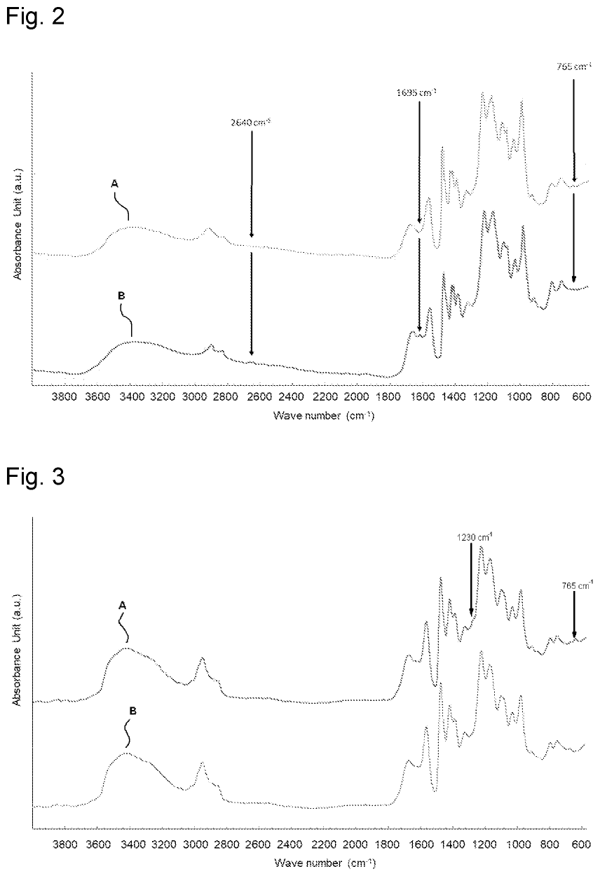

The FT-IR (ATR) spectra of formylated lignin (curve B) and formylated lignin/SP adduct (curve A) are shown in FIG. 2. The spectrum of formylated lignin showed the characteristic peaks of the aldehydic group, specifically the C═O stretching at 1695 cm⁻¹ and the C—H stretching at 2640 cm⁻¹. In the spectrum of formylated lignin/SP these peaks were not present and there was the appearance of a new peak at about 765 cm⁻¹. This peak can be attributed to the hydrogen out of plan (OPLA) of SP, as reported in (Barbera, V., et al., (2018). Domino reaction for the sustainable functionalization of few-layer graphene. Nanomaterials, 9(1), 44). This experimental evidence showed that in the formylated lignin/SP adduct the pyrrole ring was preserved. The absence of aldehydic functionality in formylated lignin/SP adduct suggests that the hydroxyls of the SP reacted with the formylated lignin to produce an acetal and/or a hemiacetal.

Elemental analysis was conducted for the quantitative evaluation of SP in formylated lignin/SP adduct by monitoring the nitrogen content, compared with pristine lignin and formylated lignin. The results are reported in Table 2.

TABLE 2

| Sample | N content % | SP content phl^{a} |
|---|---|---|
| Pristine lignin | 0.04 | — |
| Formylated lignin | 0.06 | — |
| Formylated lignin/SP adduct | 0.52 | 9 |

^{a}parts per hundred lignin

As shown in table 2, pristine lignin and formylated lignin presented lower nitrogen content respect to formylated lignin/SP adduct. The increase in nitrogen is due to the presence of SP, which contains a pyrrole ring in its structure.

### Example 11

### Preparation of Lignin/APTESP Adduct.

In a 250 round bottomed flask equipped with magnetic stirrer were poured in sequence: 10 g of lignin and acetone. A solution of 1 g of APTESP in 4 mL of acetone was prepared. This solution was added dropwise to the dispersion of lignin in acetone. Sonication was performed for 5 minutes. The system was then dried by removing the solvent (acetone) using rotavapor and was then treated at 120° C. for 4 hours under magnetic stirring (300 rpm). The final adduct was washed with acetone in order to remove the unreacted pyrrole compound.

The lignin/APTESP adduct was subjected to FT-IR (ATR) analysis, and elemental analysis.

The FT-IR (ATR) spectra of lignin (curve B) and lignin/APTESP adduct (curve A) are shown in FIG. 3. In the spectrum of the lignin/APTESP adduct (curve A), it was possible to identify the typical signals of the pyrrole molecule. Around 765 cm⁻¹, it was possible to detect the out of plan (OPLA) mode of APTESP, while the shoulder at 1230 cm⁻¹ was attributed to the stretching vibration of Si—O. The detection of OPLA peak could suggest that, after the functionalization reaction, the pyrrole ring has maintained his nature.

Based on these results and without being bound to any particular theory, it could be hypothesized that the reaction between the silane groups of APTESP and the hydroxyl groups of lignin occurred.

Elemental analysis was conducted for the quantitative evaluation of APTESP in lignin/APTESP adduct by monitoring the nitrogen content, compared with pristine lignin. The results are reported in Table 3.

TABLE 3

| Sample | N content % | APTESP content phl^{a} |
|---|---|---|
| Pristine lignin | 0.04 | — |
| Lignin/APTESP adduct | 0.17 | 3.2 |

^{a}parts per hundred lignin

Lignin/APTESP adduct has 0.17% as nitrogen content, which corresponds to 3.26% of APTESP, whereas lignin has a very low nitrogen content.

### Example 12

### Preparation of Lignin/GlyP Adduct.

10 g of lignin and 1 g of GlyP were dispersed in THF in a 250 ml flask and the solution was mixed and stirred for 10 hours at the temperature of 120° C. with the addiction of 1% w/w of acid catalyst (H₂SO₄). Dean-Stark apparatus was used in order to remove water formed during the reaction and shifts the equilibrium towards the formation of the product. The latter was finally recovered by solvent removal using rotavapor and washed with ethyl acetate to remove the unreacted GlyP.

The lignin/GlyP adduct was subjected to FT-IR (ATR) analysis, and elemental analysis.

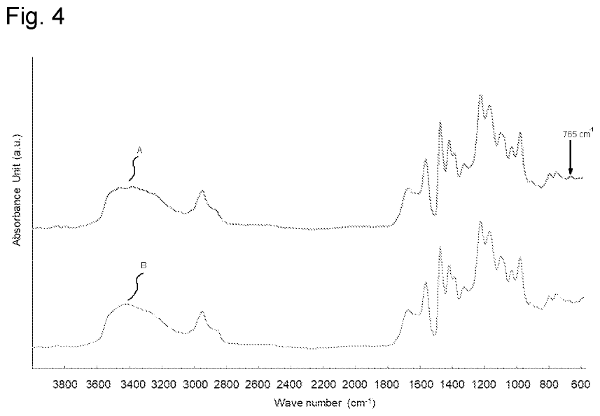

The FT-IR (ATR) spectra of lignin (curve B) and lignin/GlyP adduct (curve A) are shown in FIG. 4. In the spectrum of the lignin/GlyP adduct, it was possible to identify the typical signals of the pyrrole molecule. Around 765 cm⁻¹, it is possible to detect the out of plan (OPLA) mode of GlyP. The detection of OPLA peak could suggest that, after the functionalization reaction, the pyrrole ring has maintained his nature.

Based on these results and without being bound to any particular theory, it could be hypothesized that the reaction between the carboxylic groups of GlyP and the hydroxyl groups of lignin occurred.

Elemental analysis was conducted for the quantitative evaluation of GlyP in lignin/GlyP adduct by monitoring the nitrogen content, compared with pristine lignin. The results are reported in Table 4.

TABLE 4

| Sample | N content % | GlyP content phl^{a} |
|---|---|---|
| Pristine lignin | 0.04 | — |
| Lignin/GlyP adduct | 0.41 | 4.28 |

^{a}parts per hundred lignin

Lignin/GlyP adduct has 0.41% as nitrogen content, which corresponds to 4.28% of GlyP, whereas lignin has a very low nitrogen content.

### Preparation and Characterization of Rubber Compounds

Rubber compounds were prepared with carbon black (CB) as the only filler and with either CB-(pristine lignin) or CB-(lignin/APTESP) or CB-(lignin/SP) as the hybrid filler system. Two levels of sulfur were used: low (2 phr) and high (8.3 phr) sulfur content.

### Examples R1-R6

Preparation of Rubber Compounds with Low Sulfur Content

The following Table 5 shows the compositions of the vulcanisable elastomeric compounds R1 to R6. All the amounts are expressed in phr. Lignin/APTESP adduct contained 3.3 phl of APTESP, lignin/SP adduct contained 9.5 phl of SP.

R1 is a reference composition. R2 and R3 are comparison compositions, R4 to R6 are invention compositions.

TABLE 5

| | R1 | R2 | R3 | R4 | R5 | R6 |
|---|---|---|---|---|---|---|
| NR | 100 | 100 | 100 | 100 | 100 | 100 |
| CB | 50 | 45 | 40 | 45 | 40 | 45 |
| Pristine lignin | — | 5 | 10 | — | — | — |
| Lignin/APTESP | — | — | — | 5.15 | 10.3 | — |
| Lignin | — | — | — | 5 | 10 | — |
| APTESP | — | — | — | 0.15 | 0.3 | — |
| Lignin/SP | — | — | — | — | — | 5.5 |
| Lignin | — | — | — | — | — | 5 |
| SP | — | — | — | — | — | 0.5 |
| Stearic Acid | 2 | 2 | 2 | 2 | 2 | 2 |
| ZnO | 4 | 4 | 4 | 4 | 4 | 4 |
| 6PPD | 2 | 2 | 2 | 2 | 2 | 2 |
| TBBS | 1.8 | 1.8 | 1.8 | 1.8 | 1.8 | 1.8 |
| Sulfur | 2 | 2 | 2 | 2 | 2 | 2 |

NR: coagulated natural rubber, obtained by coagulation of natural rubber latex HA obtained by centrifugation and stabilised with ammonia (60% by weight-marketed by Von Bundit Co. Ltd);
CB: Carbon Black, N326, Cabot Corporation;
Stearic acid Stearin, Undesa;
ZnO: Zinc oxide, Zincol Ossidi;
6PPD: N-(1,3-dimethylbutyl)-N′-phenyl-p-phenylenediamine, Solutia Eastman;
TBBS: N-tert-butyl-2-benzothiazolsulphenamide, Vulkacit ® NZ/EGC, Lanxess;
Sulfur: Redball Superfine, International Sulphur Inc.

Lignin and lignin adducts with the pyrrole compounds were fed to the compound as masterbatches in natural rubber.

Pristine lignin and the adducts of lignin with the pyrrole compound were dispersed in distilled water with the help of magnetic stirring. Then NR latex wad added to the suspensions, and the mixtures were stirred for one hour. The mixtures were precipitated by adding acetic acid, the resulting masterbatches were squeezed, cut into small pieces and washed several times with distilled water to remove any residual traces of acetic acid. Finally, the masterbatches were dried at room temperature. The total amount of masterbatch and the relative amounts of NR and either pristine lignin of lignin adduct were those used in the compound.

The composites were prepared via melt blending by using an internal Brabender mixer with a chamber of 55 cm³. Firstly, masterbatches from NR latex were fed to the internal mixer at a temperature of 80° C. and were masticated for 2 minutes. Then the temperature of the chamber was decreased to 50° C. and CB was added. After 4 minutes of mastication, ZnO, together with stearic acid and 6PPD were added and mixed for 2 minutes. Eventually, TBBS and sulfur were added at the same temperature and masticated for other 2 minutes. The final rubber compounds were then discharged.

Specimen of the rubber compounds R1-R6 were subjected to MDR rheometric analysis, dynamic-mechanical analysis (axial mode) and tensile test. The results are summarized in the following tables 6 to 8.

TABLE 6

| | R1 | R2 | R3 | R4 | R5 | R6 |
|---|---|---|---|---|---|---|
| MH [dNm] | 15.4 | 14.9 | 14.1 | 19.7 | 15.1 | 19.7 |
| ML [dNm] | 2.0 | 1.9 | 1.4 | 2.0 | 2.0 | 1.5 |
| MH − ML | 13.4 | 13.0 | 12.6 | 17.6 | 13.0 | 18.1 |
| [dNm] | | | | | | |
| t90 [min] | 4.0 | 3.6 | 3.8 | 3.3 | 3.3 | 3.6 |
| tS1 [min] | 2.4 | 2.3 | 2.4 | 2.1 | 2.1 | 2.0 |
| Curing rate | 8.3 | 9.7 | 8.9 | 14.3 | 10.8 | 11.5 |
| [dNm/min] | | | | | | |

When 5 phr of pristine lignin were used in place of 5 phr of carbon black (R2), slight variations of the parameters obtained from the rheometric experiments were observed compared with R1. Increasing the amount of lignin up to 10 phr (R3) led to the reduction of moduli values, compared with R1. Compounds R2 and R3 with pristine lignin had faster vulcanization, as revealed in particular by the values of curing rate, compared with R1.

Compounds R4 and R5 comprising APTESP as lignin modifier led to the increase of the M_{H} and of the M_{H}-M_{L} values, as well as to higher curing rate, compared with reference R1 and comparison compounds R2 and R3.

Similarly, compound R6 comprising SP as lignin modifier led to the increase of the M_{H} and of the M_{H}-M_{L} values and of the curing rate.

The results from rheometer tests suggest that the functionalization of lignin with a pyrrole compound leads to the formation of an adduct chemically reactive with the elastomer chains.

TABLE 7

| | | R1 | R2 | R3 | R4 | R5 | R6 |
|---|---|---|---|---|---|---|---|
| E′ (Mpa) | 10° | 5.02 | 5.24 | 5.56 | 7.34 | 6.12 | 6.74 |
| | 23° | 4.7 | 4.72 | 4.88 | 6.41 | 5.41 | 5.43 |
| | 70° | 4.12 | 4.33 | 4.31 | 5.36 | 4.28 | 5.09 |
| E″ (MPa) | 10° | 1.18 | 1.11 | 1.16 | 1.56 | 1.13 | 1.49 |
| | 23° | 0.79 | 0.82 | 0.84 | 1.11 | 0.86 | 1.18 |
| | 70° | 0.55 | 0.51 | 0.49 | 0.61 | 0.42 | 0.64 |
| Tan δ | 10° | 0.24 | 0.21 | 0.21 | 0.21 | 0.18 | 0.22 |
| | 23° | 0.17 | 0.17 | 0.17 | 0.17 | 0.16 | 0.17 |
| | 70° | 0.13 | 0.12 | 0.11 | 0.11 | 0.09 | 0.12 |
| ΔΕ′ (Mpa) | | 0.9 | 0.91 | 1.25 | 1.98 | 1.84 | 1.65 |

ΔΕ′: Ε′ (10° C.) − E′ (70° C.)

The replacement of carbon black with pristine lignin (R2 and R3) led to similar values of E′ compared to reference R1.

The use of lignin/APTESP in place of carbon black (R4 and R5) led to higher values of E′ and to lower values of tan delta at every temperature, for both lignin contents: 5 phr and 10 phr, compared to reference R1.

The use of lignin/SP in place of carbon black (R6) led to higher values of E′ and to lower/similar values of tan delta at every temperature, compared to reference R1.

The results from axial dynamic-mechanical tests suggested that the functionalization of lignin with a pyrrole compound leads to the formation of an adduct chemically reactive with the elastomer chain.

TABLE 8

| | R1 | R2 | R3 | R4 | R5 | R6 |
|---|---|---|---|---|---|---|
| Ca1 (MPa) | 2.25 ± | 2.04 ± | 2.06 ± | 3.21 ± | 2.23 ± | 3.14 ± |
| | 0.22 | 0.01 | 0.04 | 0.13 | 0.13 | 0.07 |
| Ca2 (MPa) | 6.24 ± | 5.72 ± | 4.87 ± | 9.12 ± | 6.33 ± | 8.41 ± |
| | 0.60 | 0.11 | 0.14 | 0.40 | 0.34 | 0.19 |
| Ca3 (MPa) | 13.57 ± | 11.75 ± | 9.78 ± | 17.72 ± | 12.01 ± | 16.45 ± |
| | 0.86 | 0.23 | 0.24 | 0.67 | 0.54 | 0.23 |
| CR (MPa) | 30.81 ± | 28.1 ±8 | 27.05 ± | 25.44 ± | 24.89 ± | 24.77 ± |
| | 0.43 | 1.34 | 0.49 | 0.90 | 0.38 | 0.91 |
| AR (%) | 505.3 ± | 514.3 ± | 572.1 ± | 389.2 ± | 452.7 ± | 387.5 ± |
| | 10.4 | 20.31 | 8.64 | 18.19 | 0.59 | 10.91 |
| Energy | 59.18 ± | 60.22 ± | 61.58 ± | 42.01 ± | 43.11 ± | 37.42 ± |
| (MJ/cm3) | 1.47 | 4.38 | 1.28 | 2.92 | 1.60 | 2.23 |

The replacement of CB with pristine lignin (R2 and R3) led to lower values of stresses, at every elongation and at break, to similar or larger elongation at break and to similar energy at break compared to reference R1.

The replacement of 5 phr of CB with 5 phr of either lignin/APTESP or lignin/SP led to higher values of stresses up to 300% elongation and, as a consequence, to lower ultimate properties compared to reference R1.

The results from axial dynamic-mechanical tests suggested that the functionalization of lignin with a pyrrole compound leads to the formation of an adduct chemically reactive with the elastomer chains.

### Examples R7-R13

Preparation of Rubber Compounds with High Sulfur Content

The following Table 9 shows the compositions of the vulcanisable elastomeric compounds R7 to R13. All the amounts are expressed in phr. Lignin/APTESP adduct contained 3.3 phl of APTESP, lignin/SP adduct contained 9.5 phl of SP.

R7 is a reference composition. R8 and R9 are comparison compositions, R10 to R13 are invention compositions.

TABLE 9

| | R7 | R8 | RS | R10 | R11 | R12 | R13 |
|---|---|---|---|---|---|---|---|
| NR | 100 | 100 | 100 | 100 | 100 | 100 | 100 |
| CB | 50 | 40 | 30 | 40 | 30 | 40 | 30 |
| Pristine lignin | — | 10 | 20 | — | — | — | — |
| Lignin/APTESP | — | — | — | 10.3 | 20.6 | — | — |
| Lignin | — | — | — | 10 | 20 | — | — |
| APTESP | — | — | — | 0.3 | 0.6 | — | — |
| Lignin/SP | — | — | — | — | — | 11 | 22 |
| Lignin | — | — | — | — | — | 10 | 20 |
| SP | — | — | — | — | — | 1 | 2 |
| Stearic Acid | 5 | 5 | 5 | 5 | 5 | 5 | 5 |
| ZnO | 6 | 6 | 6 | 6 | 6 | 6 | 6 |
| 6PPD | 2 | 2 | 2 | 2 | 2 | 2 | 2 |
| CBS | 1 | 1 | 1 | 1 | 1 | 1 | 1 |
| Sulfur | 8.3 | 8.3 | 8.3 | 8.3 | 8.3 | 8.3 | 8.3 |

NR: coagulated natural rubber, obtained by coagulation of natural rubber latex HA obtained by centrifugation and stabilised with ammonia (60% by weight-marketed by Von Bundit Co. Ltd);
CB: Carbon Black, N326, Cabot Corporation;
Stearic acid : Stearin, Undesa;
ZnO: Zinc oxide, Zincol Ossidi;
6PPD: N-(1,3-dimethylbutyl)-N′-phenyl-p-phenylenediamine, Solutia Eastman;
CBS: N-cyclohexylbenzothiazole-2-sulphenamide, Rubenamid C, General Quimica;
Sulfur: Redball Superfine, International Sulphur Inc.

Lignin and lignin adducts with the pyrrole compounds were fed to the compound as masterbatches in natural rubber.

Pristine lignin and the adducts of lignin with the pyrrole compound were dispersed in distilled water with the help of magnetic stirring. Then NR latex wad added to the suspensions, and the mixtures were stirred for one hour. The mixtures were precipitated by adding acetic acid, the resulting masterbatches were squeezed, cut into small pieces and washed several times with distilled water to remove any residual traces of acetic acid. Finally, the masterbatches were dried at room temperature. The total amount of masterbatch and the relative amounts of NR and either pristine lignin of lignin adduct were those used in the compound.

The composites were prepared via melt blending by using an internal Brabender mixer with a chamber of 55 cm³. Firstly, masterbatches from NR latex were fed to the internal mixer at a temperature of 80° C. and were masticated for 2 minutes. Then the temperature of the chamber was decreased to 50° C. and CB was added. After 4 minutes of mastication, ZnO, together with stearic acid and 6PPD were added and mixed for 2 minutes. Eventually, CBS and sulfur were added at the same temperature and masticated for other 2 minutes. The final rubber compounds were then discharged.

Specimen of the rubber compounds R7-R13 were subjected to MDR rheometric analysis, dynamic-mechanical analysis (axial mode) and tensile test. The results are summarized in the following tables 10 to 12.

TABLE 10

| | R7 | R8 | R9 | R10 | R11 | R12 | R13 |
|---|---|---|---|---|---|---|---|
| MH [dNm] | 21.3 | 19.7 | 14.0 | 29.9 | 21.0 | 26.1 | 18.2 |
| ML [dNm] | 1.9 | 1.7 | 1.8 | 2.4 | 1.6 | 1.9 | 1.6 |
| MH − ML | 19.4 | 18 | 12.2 | 27.5 | 19.4 | 24.2 | 16.6 |
| [dNm] | | | | | | | |
| t90 [min] | 4.9 | 4.3 | 4.3 | 4.5 | 4.4 | 4.9 | 4.2 |
| tS1 [min] | 2.3 | 2.1 | 1.8 | 2.0 | 2.3 | 2.3 | 2.2 |
| Curing rate | 7.5 | 8.2 | 4.6 | 11.0 | 9.2 | 9.6 | 8.2 |
| [dNm/min] | | | | | | | |

The replacement of CB with pristine lignin (R8 and R9) led to similar values of M_{L}, hence to similar viscosity, and to lower values of M_{H}, M_{H}-M_{L}, tₛ₁, t₉₀ and curing rate, compared to reference compound R7. The reduction was particularly evident when 20 phr of CB were replaced with 20 phr of lignin (R9). In particular, lignin had more effect on the curing rate and on M_{H}. Hence, pristine lignin does not promote an efficient vulcanization and a high density of the crosslinking network.

By replacing 10 phr of CB with 10 phr of lignin adduct, both with APTESP and SP, the values of M_{H}, M_{H}-M_{L}, and curing rate remarkably increased, whereas the values of tₛ₁ and t₉₀ remained substantially the same, compared to reference compound R7.

By replacing 20 phr of CB with 20 phr of lignin adduct with APTESP, the values of M_{H}, M_{H}-M_{L}, tₛ₁ and t₉₀ remained substantially the same, whereas the curing rate increased, compared to reference compound R7.

By replacing 20 phr of CB with 20 phr of lignin adduct with SP, the values of M_{H}, M_{H}-M_{L}, and t₉₀ decreased, whereas the value of tₛ₁ remained substantially the same and the value of curing rate increased, compared to reference compound R7.

Taking into consideration that the lignin/SP adduct contained a larger amount of pyrrole compound, with respect to the lignin/APTESP adduct, it could be hypothesized that the different results could be due to the interaction of the pyrrole compound with sulfur and with the sulfur based crosslinking chemicals. The pyrrole compounds could act as “sulfur scavenger”, with negative effects on the crosslinking.

TABLE 11

| | | R7 | R8 | R9 | R10 | R11 | R12 | R13 |
|---|---|---|---|---|---|---|---|---|
| E′ (Mpa) | 10° | 8.34 | 8.12 | 6.87 | 10.47 | 8.51 | 10.32 | 8.44 |
| | 23° | 7.81 | 7.01 | 6.15 | 8.79 | 7.94 | 8.66 | 7.83 |
| | 70° | 7.15 | 6.21 | 5.84 | 7.89 | 7.54 | 7.56 | 7.26 |
| E″ (MPa) | 10° | 1.95 | 2.01 | 2.19 | 1.66 | 1.10 | 1.69 | 1.05 |
| | 23° | 0.94 | 0.83 | 0.94 | 0.75 | 0.51 | 0.72 | 0.50 |
| | 70° | 0.74 | 0.68 | 0.71 | 0.61 | 0.41 | 0.62 | 0.45 |
| Tan δ | 10° | 0.23 | 0.25 | 0.32 | 0.16 | 0.13 | 0.16 | 0.12 |
| | 23° | 0.12 | 0.12 | 0.15 | 0.09 | 0.06 | 0.08 | 0.06 |
| | 70° | 0.10 | 0.11 | 0.12 | 0.08 | 0.05 | 0.08 | 0.06 |
| ΔE′ (Mpa) | | 1.19 | 1.91 | 1.03 | 2.58 | 0.97 | 2.76 | 1.18 |

ΔΕ′: Ε′ (10° C.) − Ε′ (70° C.)

The replacement of CB with pristine lignin (R8 and R9) led to lower values of E′ and to higher values of Tan delta at all the temperatures, compared to reference compound R7. This is clear indication that pristine lignin is not a reinforcing filler.

By replacing CB with the lignin adduct, both with APTESP (R10 and R11) and SP (R12 and R13), higher values of E′ and lower values of Tan delta were obtained at all the temperatures, compared to reference compound R7.

These results indicated that the lignin adduct behaves as a reinforcing filler, with better results with respect to CB.

TABLE 12

| | R7 | R8 | R9 | R10 | R11 | R12 | R13 |
|---|---|---|---|---|---|---|---|
| Ca1 (MPa) | 3.8 | 3.7 | 2.9 | 4.7 | 4.1 | 4.5 | 3.8 |
| Ca2 (MPa) | 8.1 | 7.5 | 5.6 | 12.2 | 9.3 | 11.1 | 8.7 |
| CR (MPa) | 9.7 | 10.4 | 9.9 | 11.8 | 10.9 | 12.4 | 10.8 |
| AR (%) | 242.3 | 289.9 | 328.2 | 221.8 | 206.6 | 220.5 | 235.6 |
| Energy | 11.1 | 15.1 | 15.4 | 12.2 | 11.4 | 12.3 | 11.6 |
| (MJ/cm3) | | | | | | | |

The replacement of CB with pristine lignin (R8 and R9) led to lower values of stress at 100% and 200% elongation, in particular when larger amount of CB was replaced, and led to similar values of stress at break and to larger elongation at break with corresponding higher energy at break, compared to reference compound R7. These data suggested that pristine lignin does not behave as an effective reinforcing filler.

By replacing CB with the lignin adducts, both with APTESP (R10 and R11) and SP (R12 and R13), higher values of stress at 100% and 200% elongation and at break were obtained with similar (slightly lower) values of elongation at break, with higher (for 10 phr CB replacement) or similar (for 20 phr CB replacement) values of energy at break, compared to reference compound R7. These findings indicated that the lignin adducts behave as reinforcing fillers.

### Examples R14-R18

Preparation of Rubber Compounds with High Sulfur Content

The following Table 13 shows the compositions of the vulcanisable elastomeric compounds R14 to R18. All the amounts are expressed in phr. Lignin/APTESP adduct contained 3.3 phl of APTESP, lignin/SP adduct contained 9.5 phl of SP, and lignin/GlyP adduct contained 4.2 phl of Glyp.

R14 is a reference composition. R15 is a comparison composition, R16 to R18 are invention compositions.

TABLE 13

| | R14 | R15 | R16 | R17 | R18 |
|---|---|---|---|---|---|
| NR | 100 | 100 | 100 | 100 | 100 |
| CB | 50 | 35 | 35 | 35 | 35 |
| Pristine lignin | — | 15 | — | — | — |
| Lignin/APTESP | — | — | 15.4 | — | — |
| Lignin | — | — | 15 | — | — |
| APTESP | — | — | 0.4 | — | — |
| Lignin/SP | — | — | — | 16.5 | — |
| Lignin | — | — | — | 15 | — |
| SP | — | — | — | 1.5 | — |
| Lignin/GlyP | — | — | — | — | 15.6 |
| Lignin | — | — | — | — | 15 |
| GlyP | — | — | — | — | 0.6 |
| Stearic Acid | 5 | 5 | 5 | 5 | 5 |
| ZnO | 6 | 6 | 6 | 6 | 6 |
| 6PPD | 2 | 2 | 2 | 2 | 2 |
| CBS | 1 | 1 | 1 | 1 | 1 |
| Sulfur | 8.3 | 8.3 | 8.3 | 8.3 | 8.3 |

NR: coagulated natural rubber, obtained by coagulation of natural rubber latex HA obtained by centrifugation and stabilised with ammonia (60% by weight-marketed by Von Bundit Co. Ltd);
CB: Carbon Black, N326, Cabot Corporation;
Stearic acid: Stearin, Undesa;
ZnO: Zinc oxide, Zincol Ossidi;
6PPD: N-(1,3-dimethylbutyl)-N′-phenyl-p-phenylenediamine, Solutia Eastman;
CBS: N-cyclohexylbenzothiazole-2-sulphenamide, Rubenamid C, General Quimica;
Sulfur: Redball Superfine, International Sulphur Inc.

Lignin and lignin adducts with the pyrrole compounds were fed to the compound as masterbatches in natural rubber.

Pristine lignin and the adducts of lignin with the pyrrole compound were dispersed in distilled water with the help of magnetic stirring. Then NR latex wad added to the suspensions, and the mixtures were stirred for one hour. The mixtures were precipitated by adding acetic acid, the resulting masterbatches were squeezed, cut into small pieces and washed several times with distilled water to remove any residual traces of acetic acid. Finally, the masterbatches were dried at room temperature. The total amount of masterbatch and the relative amounts of NR and either pristine lignin of lignin adduct were those used in the compound.

The composites were prepared via melt blending by using an internal Brabender mixer with a chamber of 55 cm³. Firstly, masterbatches from NR latex were fed to the internal mixer at a temperature of 80° C. and were masticated for 2 minutes. Then the temperature of the chamber was decreased to 50° C. and CB was added. After 4 minutes of mastication, ZnO, together with stearic acid and 6PPD were added and mixed for 2 minutes. Eventually, CBS and sulfur were added at the same temperature and masticated for other 2 minutes. The final rubber compounds were then discharged.

Specimen of the rubber compounds R14 to R18 were subjected to MDR rheometric analysis, dynamic-mechanical analysis (axial mode) and tensile test. The results are summarized in the following tables 14 to 16.

TABLE 14

| | R14 | R15 | R16 | R17 | R18 |
|---|---|---|---|---|---|
| MH [dNm] | 21.2 | 19.4 | 29.7 | 25.7 | 30.1 |
| ML [dNm] | 1.7 | 1.6 | 2.5 | 1.9 | 1.8 |
| MH-ML [dNm] | 19.5 | 17.8 | 27.2 | 26.8 | 28.3 |
| t90 [min] | 4.8 | 4.8 | 4.5 | 4.8 | 4.4 |
| tS1 [min] | 2.9 | 2.3 | 2.1 | 2.3 | 2.1 |
| Curing rate | 9.8 | 6.9 | 11.3 | 9.6 | 11.8 |
| [dNm/min] | | | | | |

The replacement of CB with pristine lignin (R15) led to similar values of M_{L}, hence to similar viscosity, and to lower values of M_{H}, M_{H}-M_{L}, tₛ₁ and curing rate, compared with reference compound R14. In particular, lignin had more effect on the curing rate and on M_{H}. Hence, pristine lignin does not promote an efficient vulcanization and a high density of the crosslinking network.

By replacing 15 phr of CB with 15 phr of any lignin adducts (R16-R18), the values of M_{H}, M_{H}-M_{L}, and curing rate remarkably increased, whereas the values of tₛ₁ and t₉₀ remained substantially the same, compared with reference compound R14.

TABLE 15

| | | R14 | R15 | R16 | R17 | R18 |
|---|---|---|---|---|---|---|
| E′ (Mpa) | 10° | 8.24 | 7.96 | 10.52 | 10.46 | 9.66 |
| | 23° | 7.44 | 6.94 | 8.71 | 8.64 | 8.64 |
| | 70° | 7.13 | 6.23 | 7.78 | 7.51 | 7.28 |
| E″ (MPa) | 10° | 1.97 | 2.06 | 1.69 | 1.71 | 1.62 |
| | 23° | 0.91 | 0.85 | 0.71 | 0.69 | 0.81 |
| | 70° | 0.72 | 0.63 | 0.58 | 0.60 | 0.67 |
| Tan δ | 10° | 0.24 | 0.26 | 0.16 | 0.16 | 0.17 |
| | 23° | 0.12 | 0.12 | 0.08 | 0.08 | 0.09 |
| | 70° | 0.12 | 0.10 | 0.07 | 0.08 | 0.09 |

| | | | | | |
|---|---|---|---|---|---|
| ΔE′ (Mpa) | 1.11 | 1.73 | 2.74 | 2.95 | 2.38 |

ΔE′: E′(10° C.)-E′(70° C.)

The replacement of CB with pristine lignin (R15) led to lower values of E′ and similar values of Tan delta at all the temperatures, compared with reference compound R14. This is an indication that pristine lignin is not an effective reinforcing filler.

By replacing 15 phr CB with any lignin adduct (R16-R18), higher values of E′ and lower values of Tan delta were obtained at all the temperatures, compared with reference compound R14. These results indicate that the adducts behave as a reinforcing filler, with better results with respect to CB.

TABLE 16

| | R14 | R15 | R16 | R17 | R18 |
|---|---|---|---|---|---|
| Ca1 (MPa) | 3.6 | 2.8 | 4.8 | 4.5 | 3.9 |
| Ca2 (MPa) | 7.9 | 5.5 | 11.8 | 10.4 | 9.4 |
| Ca3 (MPa) | — | 8.9 | — | — | — |
| CR (MPa) | 9.4 | 9.7 | 12.1 | 11.3 | 10.7 |
| AR (%) | 254.6 | 331.4 | 224.6 | 205.3 | 207.4 |
| Energy | 11.1 | 15.1 | 12.4 | 10.9 | 11.4 |
| (MJ/cm3) | | | | | |

The replacement of CB with pristine lignin (R15) led to lower values of stress at 100% and 200% elongation, and led to similar values of stress at break and to larger elongation at break with corresponding higher energy at break, compared with reference compound R14. These data suggest that pristine lignin does not behave as reinforcing filler.

By replacing CB with the lignin adducts (R16-R18), higher values of stress at 100% and 200% elongation and at break were obtained with similar values of elongation at break, with higher or similar values of energy at break, compared with reference compound R14. These findings indicate that the lignin adducts behave as reinforcing fillers.

### Examples R19-R23

Preparation of Rubber Compounds with Low Sulfur Content and Lignin/Lignin Adduct as the Only Reinforcing Filler

The following Table 17 shows the compositions of the vulcanisable elastomeric compounds R19 to R23. All the amounts are expressed in phr. Lignin/APTESP adduct contained 3.3 phl of APTESP.

R19-21 are comparison compositions, R22 and R23 are invention compositions.

TABLE 17

| | R19 | R20 | R21 | R22 | R23 |
|---|---|---|---|---|---|
| NR | 100 | 100 | 100 | 100 | 100 |
| Pristine lignin | — | 10 | 20 | — | — |
| Lignin/APTESP | — | — | — | 10.3 | 20.6 |
| Lignin | — | — | — | 10 | 20 |
| APTESP | — | — | — | 0.3 | 0.6 |
| Stearic Acid | 2 | 2 | 2 | 2 | 2 |
| ZnO | 4 | 4 | 4 | 4 | 4 |
| 6PPD | 2 | 2 | 2 | 2 | 2 |
| TBBS | 1.8 | 1.8 | 1.8 | 1.8 | 1.8 |
| Sulfur | 1.8 | 1.8 | 1.8 | 1.8 | 1.8 |

NR: coagulated natural rubber, obtained by coagulation of natural rubber latex HA obtained by centrifugation and stabilised with ammonia (60% by weight-marketed by Von Bundit Co. Ltd);
Stearic acid: Stearin, Undesa;
ZnO: Zinc oxide, Zincol Ossidi;
6PPD: N-(1,3-dimethylbutyl)-N′-phenyl-p-phenylenediamine, Solutia Eastman;
TBBS: N-tert-butyl-2-benzothiazolsulphenamide, Vulkacit ® NZ/EGC, Lanxess;
Sulfur: Redball Superfine, International Sulphur Inc.

Lignin and lignin adducts with the pyrrole compounds were fed to the compound as masterbatches in natural rubber.

Pristine lignin and the adducts of lignin with the pyrrole compound were dispersed in distilled water with the help of magnetic stirring. Then NR latex wad added to the suspensions, and the mixtures were stirred for one hour. The mixtures were precipitated by adding acetic acid, the resulting masterbatches were squeezed, cut into small pieces and washed several times with distilled water to remove any residual traces of acetic acid. Finally, the masterbatches were dried at room temperature. The total amount of masterbatch and the relative amounts of NR and either pristine lignin of lignin adduct were those used in the compound.

The composites were prepared via melt blending by using an internal Brabender mixer with a chamber of 55 cm³. Firstly, masterbatches from NR latex were fed to the internal mixer at a temperature of 80° C. and were masticated for 2 minutes. Then the temperature of the chamber was decreased to 50° C. and lignin or lignin adduct was added, according to the recipe. After 4 minutes of mastication, ZnO, together with stearic acid and 6PPD were added and mixed for 2 minutes. Eventually, TBBS and sulfur were added at the same temperature and masticated for other 2 minutes. The final rubber compounds were then discharged.

Specimen of the rubber compounds R19 to R23 were subjected to MDR rheometric analysis, dynamic-mechanical analysis (axial mode) and tensile test. The results are summarized in the following tables 18 to 20.

TABLE 18

| | R19 | R20 | R21 | R22 | R23 |
|---|---|---|---|---|---|
| MH [dNm] | 6.2 | 4.7 | 3.9 | 6.2 | 7.7 |
| ML [dNm] | 1.1 | 0.9 | 0.9 | 1.6 | 1.8 |
| MH-ML [dNm] | 5.1 | 3.8 | 3 | 4.6 | 5.9 |
| t90 [min] | 3.9 | 3.1 | 3.2 | 2.8 | 4.7 |
| tS1 [min] | 2.5 | 1.9 | 1.9 | 2.3 | 3.1 |
| Curing rate | 3.6 | 3.2 | 2.5 | 9.2 | 3.7 |
| [dNm/min] | | | | | |

The use of lignin/APTESP in compounds R22 and R23 conferred to the rubber composites higher values of M_{H} and curing rate increase with respect to the rubber compounds R20 and R21 filled with pristine lignin. This aspect could be attributed to the fact that pristine lignin, without any functionalization, is not able to interact with sulfur vulcanization ingredients and/or with rubber chains. For this reason, it is possible to explain why, for the rubber composites filled with pristine lignin, the values of M_{H} decrease by increasing the amount of lignin.

TABLE 19

| | | R19 | R20 | R21 | R22 | R23 |
|---|---|---|---|---|---|---|
| E′ (Mpa) | 10° | 1.92 | 2.10 | 2.19 | 2.03 | 2.39 |
| | 23° | 1.84 | 2.04 | 2.16 | 1.99 | 2.37 |
| | 70° | 1.82 | 2.11 | 2.25 | 2.13 | 2.60 |
| E″ (MPa) | 10° | 0.18 | 0.22 | 0.21 | 0.20 | 0.22 |
| | 23° | 0.11 | 0.14 | 0.13 | 0.12 | 0.13 |
| | 70° | 0.06 | 0.09 | 0.07 | 0.11 | 0.11 |
| Tan δ | 10° | 0.10 | 0.11 | 0.10 | 0.10 | 0.09 |
| | 23° | 0.06 | 0.07 | 0.06 | 0.06 | 0.06 |
| | 70° | 0.03 | 0.04 | 0.03 | 0.05 | 0.04 |

| | | | | | |
|---|---|---|---|---|---|
| ΔΕ′ (Mpa) | 0.05 | 0.01 | 0.06 | 0.10 | 0.21 |

ΔE′: E′(10° C.)-E′(70° C.)

The results showed two different trends for rubber compounds filled either with 10 phr or with 20 phr filler.

The compound filled with 20 phr of lignin/APTESP adduct (R23) exhibited higher values of E′ for all the temperatures compared to the compound filled with 10 phr of pristine lignin (R21), while in the rubber compounds filled with 10 phr appreciable differences were not observed between the rubber compounds filled with lignin/APTESP (R22) or pristine lignin (R20). It is worth noting that the NR compound filled with 20 phr of lignin/APTESP adduct (R23) exhibited a noticeable increase of E′ values with the temperature increase. The increase of elastic modulus with the temperature is typical of the entropic elasticity.

TABLE 20

| | R19 | R20 | R21 | R22 | R23 |
|---|---|---|---|---|---|
| Ca0.5 (MPa) | 0.59 | 0.65 | 0.66 | 0.63 | 0.69 |
| Ca1 (MPa) | 0.87 | 1.02 | 1.01 | 0.96 | 0.97 |
| Ca3 (MPa) | 2.07 | 2.67 | 2.62 | 3.13 | 2.02 |
| CR (MPa) | 13.33 | 15.62 | 13.73 | 18.45 | 14.91 |
| AR (%) | 584.28 | 600.01 | 600.32 | 587.39 | 623.08 |
| Energy (MJ/cm³) | 18.74 | 25.91 | 23.09 | 14.44 | 21.92 |

Stress strain curves at 50% and 100% elongation were similar for all compounds, likely reflecting the low filler concentration. Some differences were observed in the properties at break of compounds filled with lignin/APTESP (R22 and R23), which had improved load at break with respect to the reference compound (R19) and the respective comparison compositions (R20 and R21). The compound filled with 10 phr of lignin/APTESP (R22) showed the highest reinforcement, at 300% elongation, with respect to all the other rubber compounds.

1-10. (canceled)

11. An adduct of lignin and a pyrrole derivative, wherein the lignin comprises at least one functional group selected from hydroxyl group (—OH), carboxyl group (—COOH), ester group (—COOR), and aldehyde group (—CHO), and wherein the pyrrole derivative has the following general formula (I): 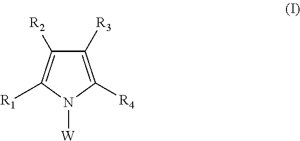
wherein
R₁-R₄ are independently selected from hydrogen atom, C₁-C₃ alkyl group, linear or branched C₂-C₁₀ alkenyl or alkynyl group, aryl group, linear or branched C₇-C₁₆ alkyl-aryl group, linear or branched C₇-C₁₆ alkenyl-aryl group, linear or branched C₇-C₁₆ alkynyl-aryl group, heteroaryl group, —CO—NHW′, and —CO—OW″;
W″ is selected from hydrogen atom, linear or branched C₁-C₁₀ alkyl group, linear or branched C₂-C₁₀ alkenyl or alkynyl group, aryl group, linear or branched C₇-C₁₆ alkyl-aryl group, linear or branched C₇-C₁₆ alkenyl-aryl group, linear or branched C₇-C₁₆ alkynyl-aryl group, and heteroaryl group,
W and W′ are independently selected from hydrogen atom, linear or branched C₁-C₁₀ alkyl group, linear or branched C₂-C₁₀ alkenyl or alkynyl group, linear or branched C₇-C₁₆ alkyl-aryl group, linear or branched C₇-C₁₆ alkenyl-aryl group, linear or branched C₇-C₁₆ alkynyl-aryl group, heteroaryl group, aryl group, cyclohexyl group, and a residue having the following formula (II): 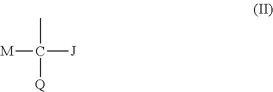
wherein M, Q and J are independently selected from hydrogen atom, amino group, hydroxyl group, linear or branched C₁-C₁₀ alkyl group, linear or branched C₂-C₁₀ alkenyl or alkynyl group, and a residue having the following formula (III): 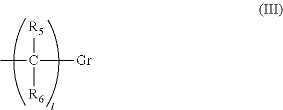
wherein I is an integer ranging from 0 to 12, R₅ and R₆ are independently selected from hydrogen atom, linear or branched C₁-C₁₀ alkyl group, linear or branched C₂-C₁₀ alkenyl or alkynyl group, aryl group, linear or branched C₇-C₁₆ alkyl-aryl group, linear or branched C₇-C₁₆ alkenyl-aryl group, linear or branched C₇-C₁₆ alkynyl-aryl group, heteroaryl group, carboxyl group, and —(CH₂)ₒ—S—R₁₆, wherein o is an integer ranging from 0 to 2, and R₁₆ is selected from hydrogen atom or C₁-C₃ alkyl group, and Gr is selected from the following residues (IV) to (IX): 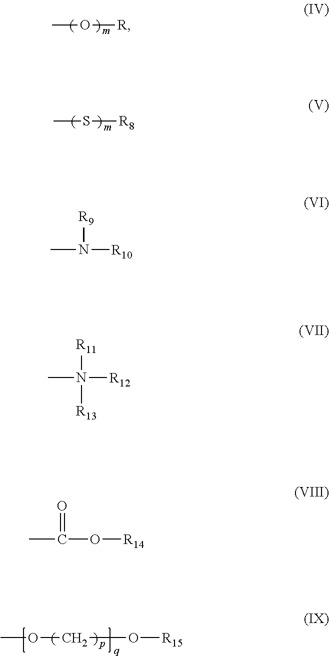
wherein m is an integer from 1 to 2, n is an integer from 1 to 4, p is an integer from 2 to 4, q is an integer from 1 to 30, R₇-R₁₅ are independently selected from hydrogen atom, linear or branched C₁-C₁₀ alkyl group, linear or branched C₂-C₁₀ alkenyl or alkynyl group, aryl, linear or branched C₇-C₁₆ alkyl-aryl group, linear or branched C₇-C₁₆ alkenyl-aryl group, linear or branched C₇-C₁₆ alkynyl-aryl group, and heteroaryl group, and R₁₁-R₁₃ can also be linear or branched C₁-C₁₀ alkoxy group.

12. A tire for vehicle wheels comprising at least one structural component comprising a vulcanized elastomeric compound comprising, before vulcanization, a vulcanisable elastomeric composition comprising:
(i) 100 phr of a composition comprising at least one diene elastomeric polymer selected from natural and synthetic diene elastomeric polymers,
(ii) from 0 phr to 100 phr of a carbon black reinforcing filler,
(iii) from 2 phr to 100 phr of the adduct of lignin and a pyrrole derivative according to claim 11, and
(iv) from 0.1 phr to 12 phr of at least one vulcanizing agent.

13. The tire for vehicle wheels according to claim 12, wherein the vulcanisable elastomeric composition comprises an amount equal to or higher than 5 phr of the adduct of lignin and a pyrrole derivative.

14. The tire for vehicle wheels according to claim 12, wherein the vulcanisable elastomeric composition comprises an amount lower than 75 phr of the adduct of lignin and a pyrrole derivative.

15. The tire for vehicle wheels according to claim 12, wherein the vulcanisable elastomeric composition comprises an amount greater than 15 phr of the carbon black reinforcing filler.

16. The tire for vehicle wheels according to claim 12, wherein the vulcanisable elastomeric composition comprises an amount lower than about 80 phr of the carbon black reinforcing filler.

17. The tire for vehicle wheels according to claim 12, wherein the vulcanisable elastomeric composition comprises between 1 phr and 70 phr, of at least one additional reinforcing filler selected from silica, silicates, alumina, aluminosilicates, paligorskite, montmorillonite, and alloisite, optionally modified by acid treatment, derivatized, or both, calcium carbonate, kaolin, and mixtures thereof.

18. The tire for vehicle wheels according to claim 12, wherein the structural element is selected from carcass structure, belt structure, additional belt layer, rubberising layer, sidewall, sidewall insert, anti-abrasive layer, bead filler, bead reinforcement layers, and tread band.

19. A green tire structural component comprising a vulcanisable elastomeric composition comprising:
(i) 100 phr of a composition comprising at least one diene elastomeric polymer selected from the group of natural and synthetic diene elastomeric polymers,
(ii) from 0 phr to 100 phr of a carbon black reinforcing filler,
(iii) from 2 phr to 100 phr of the adduct of lignin and a pyrrole derivative according to claim 11, and
(iv) from 0.1 to 12 phr of at least one vulcanizing agent.

20. The structural component according to claim 19, wherein the vulcanisable elastomeric composition comprises an amount equal to or higher than 5 phr of the adduct of lignin and a pyrrole derivative.

21. The structural component according to claim 19, wherein the vulcanisable elastomeric composition comprises an amount lower than 75 phr of the adduct of lignin and a pyrrole derivative.

22. The structural component according to claim 19, wherein the vulcanisable elastomeric composition comprises an amount greater than 15 phr of the carbon black reinforcing filler.

23. The structural component according to claim 19, wherein the vulcanisable elastomeric composition comprises an amount lower than about 80 phr of the carbon black reinforcing filler.

24. The structural component according to claim 19, wherein the vulcanisable elastomeric composition comprises between 1 phr and 70 phr, of at least one additional reinforcing filler selected from silica, silicates, alumina, aluminosilicates, paligorskite, montmorillonite, and alloisite, optionally modified by acid treatment, derivatized, or both, calcium carbonate, kaolin, and mixtures thereof.

25. The structural component according to claim 19, wherein the structural element is selected from carcass structure, belt structure, additional belt layer, rubberising layer, sidewall, sidewall insert, anti-abrasive layer, bead filler, bead reinforcement layers, and tread band.

26. A vulcanisable elastomeric composition comprising:
(i) 100 phr of a composition comprising at least one diene elastomeric polymer selected from natural and synthetic diene elastomeric polymers,
(ii) from 0 phr to 100 phr of a carbon black reinforcing filler,
(iii) from 2 phr to 100 phr of the adduct of lignin and a pyrrole derivative according to claim 11, and
(iv) from 0.1 phr to 12 phr of at least one vulcanizing agent.

27. The elastomeric composition according to claim 26, wherein the vulcanisable elastomeric composition comprises an amount equal to or higher than 5 phr of the adduct of lignin and a pyrrole derivative.

28. The elastomeric composition according to claim 26, wherein the vulcanisable elastomeric composition comprises an amount lower than 75 phr of the adduct of lignin and a pyrrole derivative.

29. The elastomeric composition according to claim 26, wherein the vulcanisable elastomeric composition comprises an amount greater than 15 phr of the carbon black reinforcing filler.

30. The elastomeric composition according to claim 26, wherein the vulcanisable elastomeric composition comprises an amount lower than about 80 phr of the carbon black reinforcing filler.

31. The elastomeric composition according to claim 26, wherein the vulcanisable elastomeric composition comprises between 1 phr and 70 phr, of at least one additional reinforcing filler selected from silica, silicates, alumina, aluminosilicates, paligorskite, montmorillonite, and alloisite, optionally modified by acid treatment, derivatized, or both, calcium carbonate, kaolin, and mixtures thereof.
